(19) United States
(12) Patent Application Publication
(10) Pub. No.: US 2017/0278465 A1
(43) Pub. Date: Sep. 28, 2017

(54) MEMS ROTATIONAL LIGHT MODULATOR WITH DISTAL LOAD ANCHORING

(71) Applicant: Pixtronix, Inc., San Diego, CA (US)

(72) Inventor: Joyce Wu, Somerville, MA (US)

(21) Appl. No.: 15/081,426

(22) Filed: Mar. 25, 2016

(51) Int. Cl. G09G 3/34; G02B 26/04

(52) U.S. Cl. CPC G09G 3/3413; G02B 26/04; G09G 2320/0666

(57) ABSTRACT

This disclosure provides systems, methods, and apparatus for display elements configured for rotational movement. A display element can include a light modulator and a first electrostatic actuator configured to induce rotational movement of the light modulator in a plane parallel to a substrate over which the display element is manufactured. A first anchor can be coupled to the substrate and positioned adjacent to a proximal end of the light modulator. A first drive beam electrode can be coupled to a second anchor. A first load beam electrode can be coupled at a first end to the first anchor and coupled at a second end to a first edge of the light modulator at a point closer to a distal end of the light modulator than to the proximal end of the light modulator.

### TECHNICAL FIELD

This disclosure relates to the field of imaging displays, and to mechanical supports incorporated into imaging displays.

### DESCRIPTION OF THE RELATED TECHNOLOGY

Electromechanical systems (EMS) include devices having electrical and mechanical elements, actuators, transducers, sensors, optical components such as mirrors and optical films, and electronics. EMS devices or elements can be manufactured at a variety of scales including, but not limited to, microscales and nanoscales. For example, microelectromechanical systems (MEMS) devices can include structures having sizes ranging from about a micron to hundreds of microns or more. Nanoelectromechanical systems (NEMS) devices can include structures having sizes smaller than a micron including, for example, sizes smaller than several hundred nanometers. Electromechanical elements may be created using deposition, etching, lithography, or a combination of these or other micromachining processes that etch away parts of substrates, the deposited material layers, or both. Such processes also may be used to add layers to form electrical and electromechanical devices.

EMS-based display apparatus can include shutters configured for translational or rotational movement in a plane above a substrate on which the shutters are manufactured. Shutters configured for rotational movement can be susceptible to out-of-plane motion that may increase required actuation voltages and decrease actuation response times.

### SUMMARY

The systems, methods and devices of this disclosure each have several innovative aspects, no single one of which is solely responsible for the desirable attributes disclosed herein.

One innovative aspect of the subject matter described in this disclosure can be implemented in a display device including a substrate, a first light modulator, and a first electrostatic actuator configured to induce rotational movement of the first light modulator in a plane substantially parallel to the substrate. The first electrostatic actuator can include a first anchor coupled to the substrate and positioned adjacent to a proximal end of the first light modulator, a first drive beam electrode coupled to a second anchor, and a first load beam electrode coupled at a first end to the first anchor, and coupled at a second end to a first edge of the first light modulator at a point closer to a distal end of the first light modulator than to the proximal end of the first light modulator. The first load beam electrode can be configured to move towards the first drive beam electrode in response to the application of a voltage across the first load beam electrode and the first drive beam electrode.

In some implementations, the display device also can include a second electrostatic actuator. The second electrostatic actuator can include a second drive beam electrode coupled to a second anchor, and a second load beam electrode opposed to the second drive beam electrode, coupled at a first end to the first anchor, and coupled at a second end to a second edge of the first light modulator, substantially opposite the first edge, at a point closer to the distal end of the first light modulator than to the proximal end of the first light modulator. The second load beam electrode can be configured to move towards the second drive beam electrode in response to the application of a voltage across the second load beam electrode and the second drive beam electrode. In some implementations, a length of the first light modulator from a center of the proximal end to a center of the distal end can be greater than a length of the first edge.

In some implementations, the display device can include an elevated aperture layer (EAL) positioned on a side of the first light modulator opposite the substrate. The EAL can be positioned within a plane substantially parallel to the substrate. The first light modulator also can include at least one light modulator aperture. The EAL can include at least one aperture aligned with the at least one light modulator aperture when the first light modulator is in an open state. In some implementations, the first load beam can have a length of less than about 100 microns.

In some implementations, the display device also can include a second light modulator adjacent to the first light modulator. The display device also can include a second electrostatic actuator configured to induce rotational movement of the second light modulator in a plane substantially parallel to the substrate. A centerline of the second light modulator can be oriented at an angle with respect to a centerline of the first light modulator when the first light modulator and the second light modulator are in an unactuated state. In some implementations, the angle formed by the centerline of the first light modulator and the centerline of the second light modulator when the first light modulator and the second light modulator are in an unactuated state can be about 90 degrees.

In some implementations, the display device also can include a second load beam electrode coupled at a first end to a second anchor, and coupled at a second end to a first edge of the second light modulator at a point closer to a distal end of the second light modulator than to the proximal end of the second light modulator. A distance between the proximal end of the first light modulator and the proximal end of the second light modulator can be shorter than a distance between the distal end of the first light modulator and the distal end of the second light modulator.

In some implementations, the display device also can include a second load beam electrode coupled at a first end to a second anchor, and coupled at a second end to a first edge of the second light modulator at a point closer to a distal end of the second light modulator than to the proximal end of the second light modulator. A distance between the distal end of the first light modulator and the distal end of the second light modulator can be shorter than a distance between the proximal end of the first light modulator and the proximal end of the second light modulator. In some implementations, the first electrostatic actuator of the first light modulator and the second electrostatic actuator of the second light modulator can share a common actuation voltage connection.

In some implementations, the display device also can include a processor capable of communicating with the display device. The processor can be capable of processing image data. The display device also can include a memory device capable of communicating with the processor. In some implementations, the display device also can include a driver circuit capable of sending at least one signal to the display device, and a controller capable of sending at least a portion of the image data to the driver circuit. In some implementations, the display device also can include an image source module capable of sending the image data to the processor. The image source module can include at least one of a receiver, transceiver, and transmitter. In some implementations, the display device also can include an input device capable of receiving input data and to communicate the input data to the processor.

Another innovative aspect of the subject matter described in this disclosure can be implemented in a display device including a substrate, a first light modulator, and a first electrostatic actuator configured to induce rotational movement of the first light modulator in a plane substantially parallel to the substrate. The first electrostatic actuator can include a first anchor coupled to the substrate and positioned adjacent to a proximal end of the first light modulator, a first drive beam electrode coupled to a second anchor, and a first load beam electrode coupled at a first end to the first anchor, and coupled at a second end to a first distal edge of the first light modulator away from the proximal end. The first load beam electrode can be configured to move towards the first drive beam electrode in response to the application of a voltage across the first load beam electrode and the first drive beam electrode.

In some implementations, the display device can include a second electrostatic actuator including a second drive beam electrode coupled to a second anchor, and a second load beam electrode opposed to the second drive beam electrode, coupled at a first end to the first anchor, and coupled at a second end to a second distal edge of the first light modulator, substantially opposite the first distal edge and away from the proximal end. The second load beam electrode can be configured to move towards the second drive beam electrode in response to the application of a voltage across the second load beam electrode and the second drive beam electrode. In some implementations, a length of the first light modulator from a center of the proximal end to a center of the distal end can be greater than a length of an edge of the first light modulator connecting the proximal end and the distal end.

In some implementations, the display device can include an elevated aperture layer (EAL) positioned on a side of the first light modulator opposite the substrate. The EAL can be positioned within a plane substantially parallel to the substrate. The first light modulator also can include at least one light modulator aperture. The EAL can include at least one aperture aligned with the at least one light modulator aperture when the first light modulator is in an open state. In some implementations, the first load beam can have a length of less than about 100 microns.

In some implementations, the display device also can include a second light modulator adjacent to the first light modulator. The display device also can include a second electrostatic actuator configured to induce rotational movement of the second light modulator in a plane substantially parallel to the substrate. A centerline of the second light modulator can be oriented at an angle with respect to a centerline of the first light modulator when the first light modulator and the second light modulator are in an unactuated state. In some implementations, the angle formed by the centerline of the first light modulator and the centerline of the second light modulator when the first light modulator and the second light modulator are in an unactuated state can be about 90 degrees.

In some implementations, the display device can include a second load beam electrode coupled at a first end to a second anchor, and coupled at a second end to a first edge of the second light modulator at a point closer to a distal end of the second light modulator than to the proximal end of the second light modulator. A distance between the proximal end of the first light modulator and the proximal end of the second light modulator can be shorter than a distance between the distal end of the first light modulator and the distal end of the second light modulator.

In some implementations, the display device can include a second load beam electrode coupled at a first end to a second anchor, and coupled at a second end to a first edge of the second light modulator at a point closer to a distal end of the second light modulator than to the proximal end of the second light modulator. A distance between the distal end of the first light modulator and the distal end of the second light modulator can be shorter than a distance between the proximal end of the first light modulator and the proximal end of the second light modulator. In some implementations, the first electrostatic actuator of the first light modulator and the second electrostatic actuator of the second light modulator can share a common actuation voltage connection.

Another innovative aspect of the subject matter described in this disclosure can be implemented in a display device including a substrate, a first light modulator, a first anchor coupled to the substrate and positioned adjacent to a proximal end of the first light modulator, and a first electrostatic actuator configured to induce rotational movement of the first light modulator in a plane substantially parallel to the substrate. The first electrostatic actuator can include a first drive beam electrode coupled to a second anchor, a first load beam electrode coupled at a first end to the first anchor, and coupled at a second end to a first edge of the first light modulator, and a second load beam electrode coupled at a first end to the first anchor, and coupled at a second end to a second edge of the first light modulator. The first light modulator can be positioned between the first load beam electrode and the second load beam electrode.

In some implementations, the display device can include a second electrostatic actuator configured to induce rotational movement of the first light modulator in the plane substantially parallel to the substrate. The second electrostatic actuator can include the second load beam electrode and a second drive beam electrode opposed to the second load beam electrode and coupled to a third anchor. In some implementations, the first light modulator can include at least a first light modulator aperture and a second light modulator aperture. An area of the first light modulator aperture can be larger than an area of the second light modulator aperture.

In some implementations, the display device can include an elevated aperture layer (EAL) positioned on a side of the first light modulator opposite the substrate. The EAL can be positioned within a plane substantially parallel to the substrate. The EAL can include at least two apertures each aligned with a respective one of the first light modulator aperture and the second light modulator aperture when the first light modulator is in an open state. In some implementations, the first load beam can have a length of less than about 100 microns.

In some implementations, the display device can include a second light modulator adjacent to the first light modulator, and a second electrostatic actuator configured to induce rotational movement of the second light modulator in a plane substantially parallel to the substrate. A centerline of the second light modulator can be oriented at an angle with respect to a centerline of the first light modulator when the first light modulator and the second light modulator are in an unactuated state.

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

### BRIEF DESCRIPTION OF THE DRAWINGS

FIG. 1A shows a schematic diagram of an example direct-view microelectromechanical systems (MEMS)-based display apparatus.

FIG. 1B shows a block diagram of an example host device.

FIGS. 2A and 2B show views of an example dual actuator shutter assembly.

FIG. 3A shows a top view of an example shutter-based light modulator.

FIG. 3B shows a cross-sectional view of an example display device including the example shutter-based light modulator shown in FIG. 3A.

FIG. 3C shows a top view of an example array of shutter-based light modulators having drive beam anchors wired according to a first example wiring pattern.

FIG. 3D shows a top view of the example array of shutter-based light modulators having drive beam anchors wired according to a second example wiring pattern.

FIG. 3E shows a top view of another example array of shutter-based light modulators.

FIG. 4A shows a top view of another example shutter-based light modulator.

FIG. 4B shows a cross-sectional view of an example display device including the example shutter-based light modulator shown in FIG. 4A.

FIG. 4C shows a top view of an example array of shutter-based light modulators having drive beam anchors wired according to a first example wiring pattern.

FIG. 4D shows a top view of the example array of shutter-based light modulators having drive beam anchors wired according to a second example wiring pattern.

FIG. 4E shows a top view of another example array of shutter-based light modulators.

FIG. 5 shows a flow chart of an example process for manufacturing a display device.

FIGS. 6A and 6B show system block diagrams of an example display device that includes a plurality of display elements.

Like reference numbers and designations in the various drawings indicate like elements.

### DETAILED DESCRIPTION

The following description is directed to certain implementations for the purposes of describing the innovative aspects of this disclosure. However, a person having ordinary skill in the art will readily recognize that the teachings herein can be applied in a multitude of different ways. The described implementations may be implemented in any device, apparatus, or system that is capable of displaying an image, whether in motion (such as video) or stationary (such as still images), and whether textual, graphical or pictorial. The concepts and examples provided in this disclosure may be applicable to a variety of displays, such as liquid crystal displays (LCDs), organic light-emitting diode (OLED) displays, field emission displays, and electromechanical systems (EMS) and microelectromechanical (MEMS)-based displays, in addition to displays incorporating features from one or more display technologies.

The described implementations may be included in or associated with a variety of electronic devices such as, but not limited to: mobile telephones, multimedia Internet enabled cellular telephones, mobile television receivers, wireless devices, smartphones, Bluetooth® devices, personal data assistants (PDAs), wireless electronic mail receivers, hand-held or portable computers, netbooks, notebooks, smartbooks, tablets, printers, copiers, scanners, facsimile devices, global positioning system (GPS) receivers/navigators, cameras, digital media players (such as MP3 players), camcorders, game consoles, wrist watches, wearable devices, clocks, calculators, television monitors, flat panel displays, electronic reading devices (such as e-readers), computer monitors, auto displays (such as odometer and speedometer displays), cockpit controls or displays, camera view displays (such as the display of a rear view camera in a vehicle), electronic photographs, electronic billboards or signs, projectors, architectural structures, microwaves, refrigerators, stereo systems, cassette recorders or players, DVD players, CD players, VCRs, radios, portable memory chips, washers, dryers, washer/dryers, parking meters, packaging (such as in electromechanical systems (EMS) applications including microelectromechanical systems (MEMS) applications, in addition to non-EMS applications), aesthetic structures (such as display of images on a piece of jewelry or clothing) and a variety of EMS devices.

The teachings herein also can be used in non-display applications such as, but not limited to, electronic switching devices, radio frequency filters, sensors, accelerometers, gyroscopes, motion-sensing devices, magnetometers, inertial components for consumer electronics, parts of consumer electronics products, varactors, liquid crystal devices, electrophoretic devices, drive schemes, manufacturing processes and electronic test equipment. Thus, the teachings are not intended to be limited to the implementations depicted solely in the Figures, but instead have wide applicability as will be readily apparent to one having ordinary skill in the art.

A display device can produce images by modulating light using an array of light modulators. In some implementations, a light modulator can include an EMS-based shutter that is configured to move rotationally in a plane above a substrate on which the light modulator is formed. An anchor can be positioned adjacent to a proximal end of the shutter and coupled to the substrate. Load beams can couple at one end to the anchor and at another end to opposite edges of the light modulator, such that each load beam extends along a respective edge of the shutter. In some implementations, each load beam may couple to the shutter at a point closer to a distal end of the shutter than to the proximal end of the shutter.

A drive beam electrode can be positioned alongside the shutter and opposed to one of the load beams. Together, the drive beam and the opposing load beam can form an electrostatic actuator configured to move the shutter rotationally above the substrate. When an actuation voltage is applied across the drive beam and the opposing load beam, the load beam can deform towards the drive beam (and the drive beam also can deform towards the load beam), thereby pulling the shutter along a substantially arcuate path into an open or closed position with respect to one or more apertures formed in one or more light blocking layers which may be positioned above the shutter, below the shutter, or both above and below the shutter. In some implementations, the drive beam may extend out from a drive beam anchor and loop back towards the drive beam anchor to form a closed loop. In some other implementations, the drive beam may be a single-sided drive beam that does not form a closed loop. In some implementations, a rotational light modulator may include a second drive beam positioned on a side of the shutter opposite the first drive beam and opposed to the other load beam. The second drive beam and its respective opposing load beam can form a second electrostatic actuator configured to move the shutter rotationally in a direction rotationally opposite the direction of the first electrostatic actuator.

In some implementations, the shutter of a rotational light modulator may not include an aperture. Light can be modulated by moving the shutter in and out of an optical path between apertures formed in an adjacent aperture layer. In some other implementations, the shutter of a rotational light modulator may include at least one shutter aperture that is aligned with a respective aperture formed in a light blocking layer above or below the shutter when the shutter is in an open state. The shutter may include one, two, three, four, or more shutter apertures. An area of one of the shutter apertures may differ from an area of at least one other shutter aperture. For example, in some implementations, the shutter may be shaped such that a substantial portion of the shutter extends beyond an arc that passes through the points at which the load beams connect to the shutter. In other words, a centerline of the shutter from the proximal end to the distal end may be longer than each lateral edge of the shutter. An aperture aligned with the centerline of the shutter may have a larger area than an aperture closer to an edge of the shutter.

In some implementations, two or more rotational light modulators can be arranged adjacent to one another to form a pixel. For example, each light modulator may be associated with a different color of light. Each pixel may include two, three, four, or more light modulators. In some implementations, multiple light modulators can be used to implement area division grey scale. In some other implementations, each light modulator within a pixel can be associated with a particular color of light, such as red, green, blue, and white (RGBW), and the light modulators can be configured to produce a desired composite color output for the pixel. In still other implementations, multiple light modulators per pixel can be used to provide redundancy in case one or more of the light modulators associated with a pixel fails. Drive beam electrodes of some adjacent light modulators may be electrically connected. In some implementations, the light modulators for each pixel can be arranged in a radially symmetric fashion around the center of the pixel. In some implementations, the light modulators can be arranged such that the distal ends of the shutters face away from the center of each pixel. In some other implementations, the light modulators can be arranged such that the distal ends of the shutters face towards the center of each pixel.

Particular implementations of the subject matter described in this disclosure can be implemented to realize one or more of the following potential advantages. Configuring the shutters of light modulators for rotational movement can allow for reduced actuation voltages, reduced actuation times, and larger aperture ratios, relative to light modulators having shutters configured for translational movement. For example, shutter travel distance may be smaller, and the number of apertures per light modulator may be larger for shutters configured to move rotationally.

By designing a rotational shutter that has a portion which extends beyond an arc passing through the points at which the load beams couple to the shutter, the aperture ratio can be improved. For example, such a shutter shape can increase the size of the shutter, and a larger aperture can be positioned in the space occupied by the extended portion of the shutter. Furthermore, these benefits can be achieved without an increase in actuation voltage.

Arranging light modulators in a radially symmetric fashion around a center of each pixel can allow for increased aperture ratio and improved uniformity of viewing angles. For example, a radially symmetric arrangement can be a spatially efficient way to layout adjacent light modulators, and can allow drive beam electrodes of adjacent light modulators (or in some cases, an entire row or column of light modulators) to share an electrical connection, such that unused space on the substrate is reduced. In some implementations, the drive beams of adjacent light modulators can be coupled to a shared anchor that supplies an electrical voltage to the drive beams of both of the adjacent light modulators. As a result of reducing unused space on the substrate, the size of the apertures can be increased and therefore the aperture ratio of the display device can be increased relative to the aperture ratio of a display device that does not exhibit such radial symmetry. Radial symmetry also allows for light modulators within each pixel to be arranged at angles with respect to one another. Because the angular distribution of light through a light modulator depends in part on the orientation of the light modulator, the differing angles of light modulators within a single pixel can help to improve the angular distribution of light through the pixel, which can result in greater viewing angle uniformity.

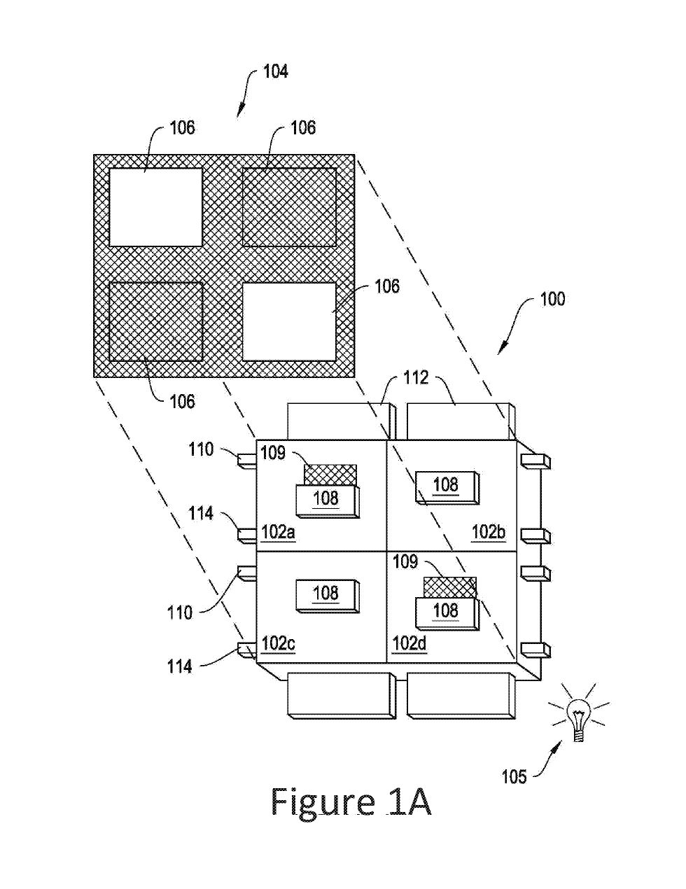

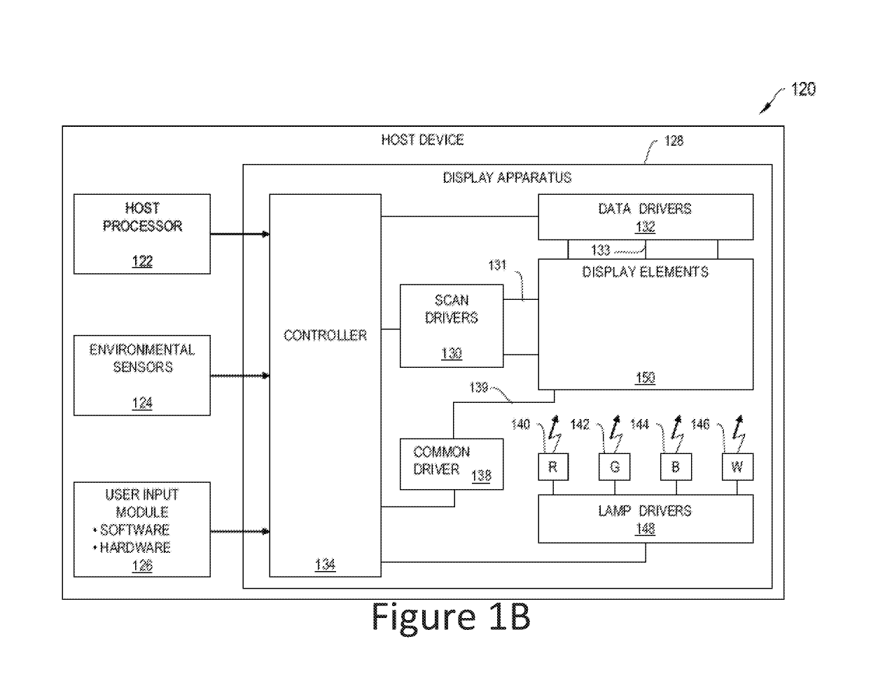

FIG. 1A shows a schematic diagram of an example direct-view MEMS-based display apparatus 100. The display apparatus 100 includes a plurality of light modulators 102a-102d (generally light modulators 102) arranged in rows and columns. In the display apparatus 100, the light modulators 102a and 102d are in the open state, allowing light to pass. The light modulators 102b and 102c are in the closed state, obstructing the passage of light. By selectively setting the states of the light modulators 102a-102d, the display apparatus 100 can be utilized to form an image 104 for a backlit display, if illuminated by a lamp or lamps 105. In another implementation, the apparatus 100 may form an image by reflection of ambient light originating from the front of the apparatus. In another implementation, the apparatus 100 may form an image by reflection of light from a lamp or lamps positioned in the front of the display, i.e., by use of a front light.

In some implementations, each light modulator 102 corresponds to a pixel 106 in the image 104. In some other implementations, the display apparatus 100 may utilize a plurality of light modulators to form a pixel 106 in the image 104. For example, the display apparatus 100 may include three color-specific light modulators 102. By selectively opening one or more of the color-specific light modulators 102 corresponding to a particular pixel 106, the display apparatus 100 can generate a color pixel 106 in the image 104. In another example, the display apparatus 100 includes two or more light modulators 102 per pixel 106 to provide a luminance level in an image 104. With respect to an image, a pixel corresponds to the smallest picture element defined by the resolution of image. With respect to structural components of the display apparatus 100, the term pixel refers to the combined mechanical and electrical components utilized to modulate the light that forms a single pixel of the image.

The display apparatus 100 is a direct-view display in that it may not include imaging optics typically found in projection applications. In a projection display, the image formed on the surface of the display apparatus is projected onto a screen or onto a wall. The display apparatus is substantially smaller than the projected image. In a direct view display, the image can be seen by looking directly at the display apparatus, which contains the light modulators and optionally a backlight or front light for enhancing brightness of the display, the contrast of the display, or both.

Direct-view displays may operate in either a transmissive or reflective mode. In a transmissive display, the light modulators filter or selectively block light which originates from a lamp or lamps positioned behind the display. The light from the lamps is optionally injected into a lightguide or backlight so that each pixel can be uniformly illuminated. Transmissive direct-view displays are often built onto transparent substrates to facilitate a sandwich assembly arrangement where one substrate, containing the light modulators, is positioned over the backlight. In some implementations, the transparent substrate can be a glass substrate (sometimes referred to as a glass plate or panel), or a plastic substrate. The glass substrate may be or include, for example, a borosilicate glass, fused silica, a soda lime glass, quartz, artificial quartz, Pyrex, or other suitable glass material.

Each light modulator 102 can include a shutter 108 and an aperture 109. To illuminate a pixel 106 in the image 104, the shutter 108 is positioned such that it allows light to pass through the aperture 109. To keep a pixel 106 unlit, the shutter 108 is positioned such that it obstructs the passage of light through the aperture 109. The aperture 109 is defined by an opening patterned through a reflective or light-absorbing material in each light modulator 102.

The display apparatus also includes a control matrix coupled to the substrate and to the light modulators for controlling the movement of the shutters. The control matrix includes a series of electrical interconnects (such as interconnects 110, 112 and 114), including at least one write-enable interconnect 110 (also referred to as a scan line interconnect) per row of pixels, one data interconnect 112 for each column of pixels, and one common interconnect 114 providing a common voltage to all pixels, or at least to pixels from both multiple columns and multiples rows in the display apparatus 100. In response to the application of an appropriate voltage (the write-enabling voltage, V_{WE}), the write-enable interconnect 110 for a given row of pixels prepares the pixels in the row to accept new shutter movement instructions. The data interconnects 112 communicate the new movement instructions in the form of data voltage pulses. The data voltage pulses applied to the data interconnects 112, in some implementations, directly contribute to an electrostatic movement of the shutters. In some other implementations, the data voltage pulses control switches, such as transistors or other non-linear circuit elements that control the application of separate drive voltages, which are typically higher in magnitude than the data voltages, to the light modulators 102. The application of these drive voltages results in the electrostatic driven movement of the shutters 108.

The control matrix also may include, without limitation, circuitry, such as a transistor and a capacitor associated with each shutter assembly. In some implementations, the gate of each transistor can be electrically connected to a scan line interconnect. In some implementations, the source of each transistor can be electrically connected to a corresponding data interconnect. In some implementations, the drain of each transistor may be electrically connected in parallel to an electrode of a corresponding capacitor and to an electrode of a corresponding actuator. In some implementations, the other electrode of the capacitor and the actuator associated with each shutter assembly may be connected to a common or ground potential. In some other implementations, the transistor can be replaced with a semiconducting diode, or a metal-insulator-metal switching element.

FIG. 1B shows a block diagram of an example host device 120 (i.e., cell phone, smart phone, PDA, MP3 player, tablet, e-reader, netbook, notebook, watch, wearable device, laptop, television, or other electronic device). The host device 120 includes a display apparatus 128 (such as the display apparatus 100 shown in FIG. 1A), a host processor 122, environmental sensors 124, a user input module 126, and a power source.

The display apparatus 128 includes a plurality of scan drivers 130 (also referred to as write enabling voltage sources), a plurality of data drivers 132 (also referred to as data voltage sources), a controller 134, common drivers 138, lamps 140-146, lamp drivers 148 and an array of display elements 150, such as the light modulators 102 shown in FIG. 1A. The scan drivers 130 apply write enabling voltages to scan line interconnects 131. The data drivers 132 apply data voltages to the data interconnects 133.

In some implementations of the display apparatus, the data drivers 132 are capable of providing analog data voltages to the array of display elements 150, especially where the luminance level of the image is to be derived in analog fashion. In analog operation, the display elements are designed such that when a range of intermediate voltages is applied through the data interconnects 133, there results a range of intermediate illumination states or luminance levels in the resulting image. In some other implementations, the data drivers 132 are capable of applying a reduced set, such as 2, 3 or 4, of digital voltage levels to the data interconnects 133. In implementations in which the display elements are shutter-based light modulators, such as the light modulators 102 shown in FIG. 1A, these voltage levels are designed to set, in digital fashion, an open state, a closed state, or other discrete state to each of the shutters 108. In some implementations, the drivers are capable of switching between analog and digital modes.

The scan drivers 130 and the data drivers 132 are connected to a digital controller circuit 134 (also referred to as the controller 134). The controller 134 sends data to the data drivers 132 in a mostly serial fashion, organized in sequences, which in some implementations may be predetermined, grouped by rows and by image frames. The data drivers 132 can include series-to-parallel data converters, level-shifting, and for some applications digital-to-analog voltage converters.

The display apparatus optionally includes a set of common drivers 138, also referred to as common voltage sources. In some implementations, the common drivers 138 provide a DC common potential to all display elements within the array 150 of display elements, for instance by supplying voltage to a series of common interconnects 139. In some other implementations, the common drivers 138, following commands from the controller 134, issue voltage pulses or signals to the array of display elements 150, for instance global actuation pulses which are capable of driving or initiating simultaneous actuation of all display elements in multiple rows and columns of the array.

Each of the drivers (such as scan drivers 130, data drivers 132 and common drivers 138) for different display functions can be time-synchronized by the controller 134. Timing commands from the controller 134 coordinate the illumination of red, green, blue and white lamps (140, 142, 144 and 146 respectively) via lamp drivers 148, the write-enabling and sequencing of specific rows within the array of display elements 150, the output of voltages from the data drivers 132, and the output of voltages that provide for display element actuation. In some implementations, the lamps are light emitting diodes (LEDs).

The controller 134 determines the sequencing or addressing scheme by which each of the display elements can be re-set to the illumination levels appropriate to a new image 104. New images 104 can be set at periodic intervals. For instance, for video displays, color images or frames of video are refreshed at frequencies ranging from 10 to 300 Hertz (Hz). In some implementations, the setting of an image frame to the array of display elements 150 is synchronized with the illumination of the lamps 140, 142, 144 and 146 such that alternate image frames are illuminated with an alternating series of colors, such as red, green, blue and white. The image frames for each respective color are referred to as color subframes. In this method, referred to as the field sequential color method, if the color subframes are alternated at frequencies in excess of 20 Hz, the human visual system (HVS) will average the alternating frame images into the perception of an image having a broad and continuous range of colors. In some other implementations, the lamps can employ primary colors other than red, green, blue and white. In some implementations, fewer than four, or more than four lamps with primary colors can be employed in the display apparatus 128.

In some implementations, where the display apparatus 128 is designed for the digital switching of shutters, such as the shutters 108 shown in FIG. 1A, between open and closed states, the controller 134 forms an image by the method of time division gray scale. In some other implementations, the display apparatus 128 can provide gray scale through the use of multiple display elements per pixel.

In some implementations, the data for an image state is loaded by the controller 134 to the array of display elements 150 by a sequential addressing of individual rows, also referred to as scan lines. For each row or scan line in the sequence, the scan driver 130 applies a write-enable voltage to the write enable interconnect 131 for that row of the array of display elements 150, and subsequently the data driver 132 supplies data voltages, corresponding to desired shutter states, for each column in the selected row of the array. This addressing process can repeat until data has been loaded for all rows in the array of display elements 150. In some implementations, the sequence of selected rows for data loading is linear, proceeding from top to bottom in the array of display elements 150. In some other implementations, the sequence of selected rows is pseudo-randomized, in order to mitigate potential visual artifacts. And in some other implementations, the sequencing is organized by blocks, where, for a block, the data for a certain fraction of the image is loaded to the array of display elements 150. For example, the sequence can be implemented to address every fifth row of the array of the display elements 150 in sequence.

In some implementations, the addressing process for loading image data to the array of display elements 150 is separated in time from the process of actuating the display elements. In such an implementation, the array of display elements 150 may include data memory elements for each display element, and the control matrix may include a global actuation interconnect for carrying trigger signals, from the common driver 138, to initiate simultaneous actuation of the display elements according to data stored in the memory elements.

In some implementations, the array of display elements 150 and the control matrix that controls the display elements may be arranged in configurations other than rectangular rows and columns. For example, the display elements can be arranged in hexagonal arrays or curvilinear rows and columns.

The host processor 122 generally controls the operations of the host device 120. For example, the host processor 122 may be a general or special purpose processor for controlling a portable electronic device. With respect to the display apparatus 128, included within the host device 120, the host processor 122 outputs image data as well as additional data about the host device 120. Such information may include data from environmental sensors 124, such as ambient light or temperature; information about the host device 120, including, for example, an operating mode of the host or the amount of power remaining in the host device's power source; information about the content of the image data; information about the type of image data; instructions for the display apparatus 128 for use in selecting an imaging mode; or any combination of these types of information.

In some implementations, the user input module 126 enables the conveyance of personal preferences of a user to the controller 134, either directly, or via the host processor 122. In some implementations, the user input module 126 is controlled by software in which a user inputs personal preferences, for example, color, contrast, power, brightness, content, and other display settings and parameters preferences. In some other implementations, the user input module 126 is controlled by hardware in which a user inputs personal preferences. In some implementations, the user may input these preferences via voice commands, one or more buttons, switches or dials, or with touch-capability. The plurality of data inputs to the controller 134 direct the controller to provide data to the various drivers 130, 132, 138 and 148 which correspond to optimal imaging characteristics.

The environmental sensor module 124 also can be included as part of the host device 120. The environmental sensor module 124 can be capable of receiving data about the ambient environment, such as temperature and or ambient lighting conditions. The sensor module 124 can be programmed, for example, to distinguish whether the device is operating in an indoor or office environment versus an outdoor environment in bright daylight versus an outdoor environment at nighttime. The sensor module 124 communicates this information to the display controller 134, so that the controller 134 can optimize the viewing conditions in response to the ambient environment.

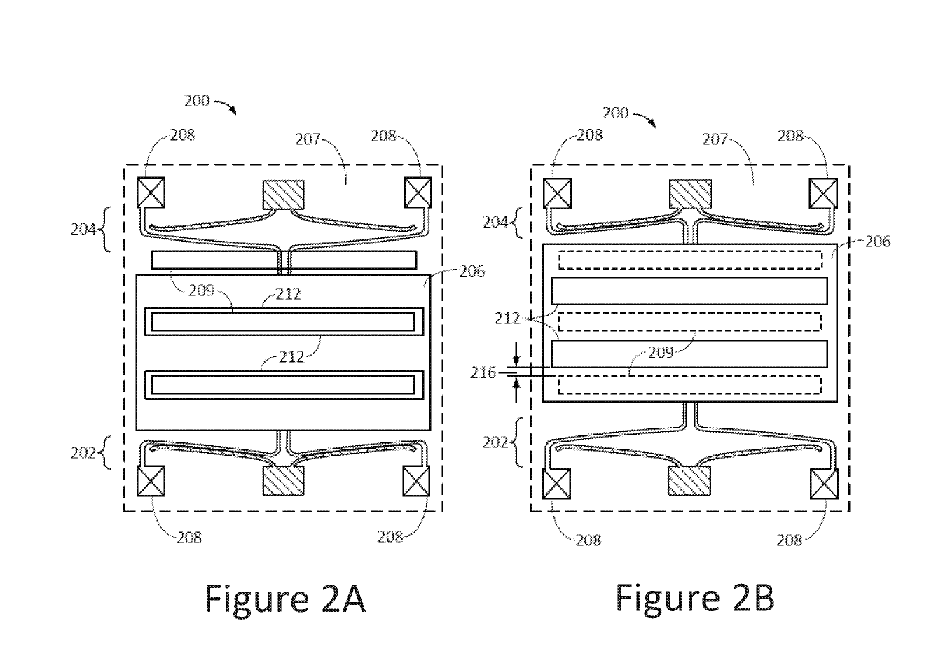

FIGS. 2A and 2B show views of an example dual actuator shutter assembly 200. The dual actuator shutter assembly 200, as depicted in FIG. 2A, is in an open state. FIG. 2B shows the dual actuator shutter assembly 200 in a closed state. The shutter assembly 200 includes actuators 202 and 204 on either side of a shutter 206. Each actuator 202 and 204 is independently controlled. A first actuator, a shutter-open actuator 202, serves to open the shutter 206. A second opposing actuator, the shutter-close actuator 204, serves to close the shutter 206. Each of the actuators 202 and 204 can be implemented as compliant beam electrode actuators. The actuators 202 and 204 open and close the shutter 206 by driving the shutter 206 substantially in a plane parallel to an aperture layer 207 over which the shutter is suspended. The shutter 206 is suspended a short distance over the aperture layer 207 by anchors 208 attached to the actuators 202 and 204. Having the actuators 202 and 204 attach to opposing ends of the shutter 206 along its axis of movement reduces out of plane motion of the shutter 206 and confines the motion substantially to a plane parallel to the substrate (not depicted).

In the depicted implementation, the shutter 206 includes two shutter apertures 212 through which light can pass. The aperture layer 207 includes a set of three apertures 209. In FIG. 2A, the shutter assembly 200 is in the open state and, as such, the shutter-open actuator 202 has been actuated, the shutter-close actuator 204 is in its relaxed position, and the centerlines of the shutter apertures 212 coincide with the centerlines of two of the aperture layer apertures 209. In FIG. 2B, the shutter assembly 200 has been moved to the closed state and, as such, the shutter-open actuator 202 is in its relaxed position, the shutter-close actuator 204 has been actuated, and the light blocking portions of the shutter 206 are now in position to block transmission of light through the apertures 209 (depicted as dotted lines).

Each aperture has at least one edge around its periphery. For example, the rectangular apertures 209 have four edges. In some implementations, in which circular, elliptical, oval, or other curved apertures are formed in the aperture layer 207, each aperture may have a single edge. In some other implementations, the apertures need not be separated or disjointed in the mathematical sense, but instead can be connected. That is to say, while portions or shaped sections of the aperture may maintain a correspondence to each shutter, several of these sections may be connected such that a single continuous perimeter of the aperture is shared by multiple shutters.

In order to allow light with a variety of exit angles to pass through the apertures 212 and 209 in the open state, the width or size of the shutter apertures 212 can be designed to be larger than a corresponding width or size of apertures 209 in the aperture layer 207. In order to effectively block light from escaping in the closed state, the light blocking portions of the shutter 206 can be designed to overlap the edges of the apertures 209. FIG. 2B shows an overlap 216, which in some implementations can be predefined, between the edge of light blocking portions in the shutter 206 and one edge of the aperture 209 formed in the aperture layer 207.

The electrostatic actuators 202 and 204 are designed so that their voltage-displacement behavior provides a bi-stable characteristic to the shutter assembly 200. For each of the shutter-open and shutter-close actuators, there exists a range of voltages below the actuation voltage, which if applied while that actuator is in the closed state (with the shutter being either open or closed), will hold the actuator closed and the shutter in position, even after a drive voltage is applied to the opposing actuator. The minimum voltage needed to maintain a shutter's position against such an opposing force is referred to as a maintenance voltage Vₘ.

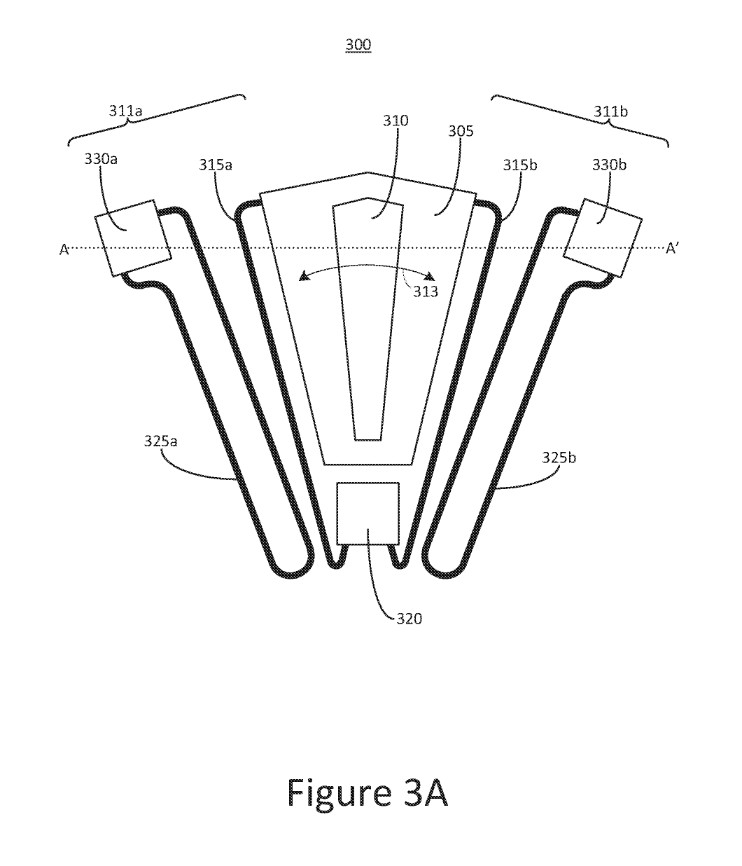

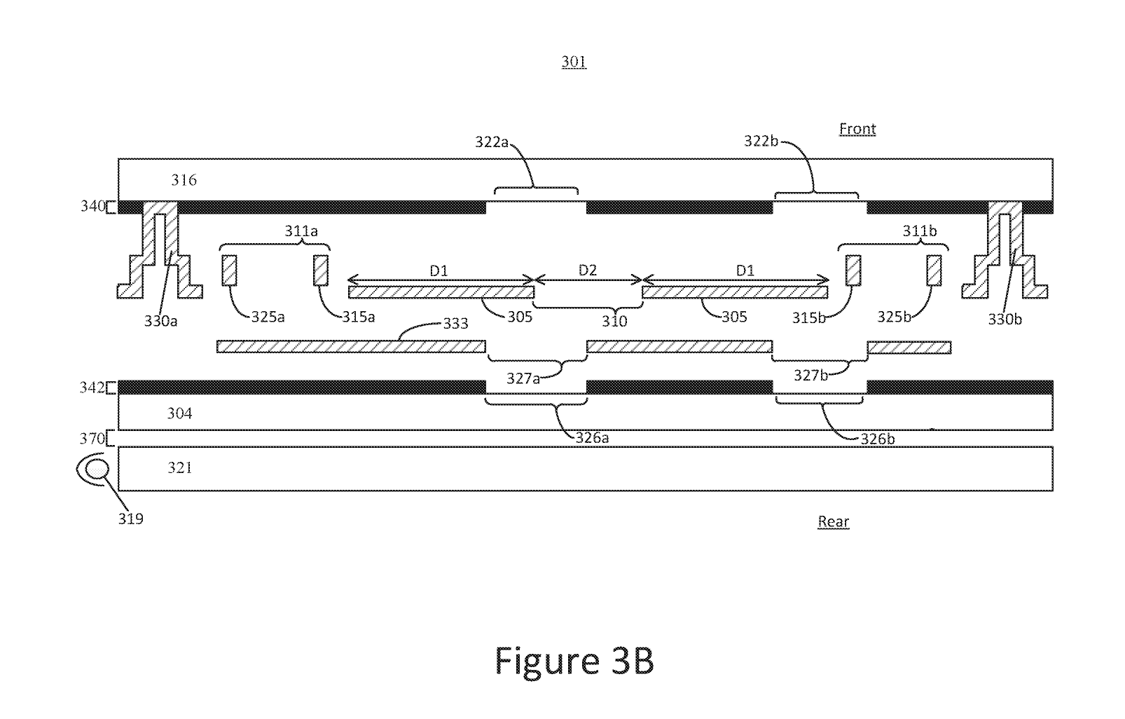

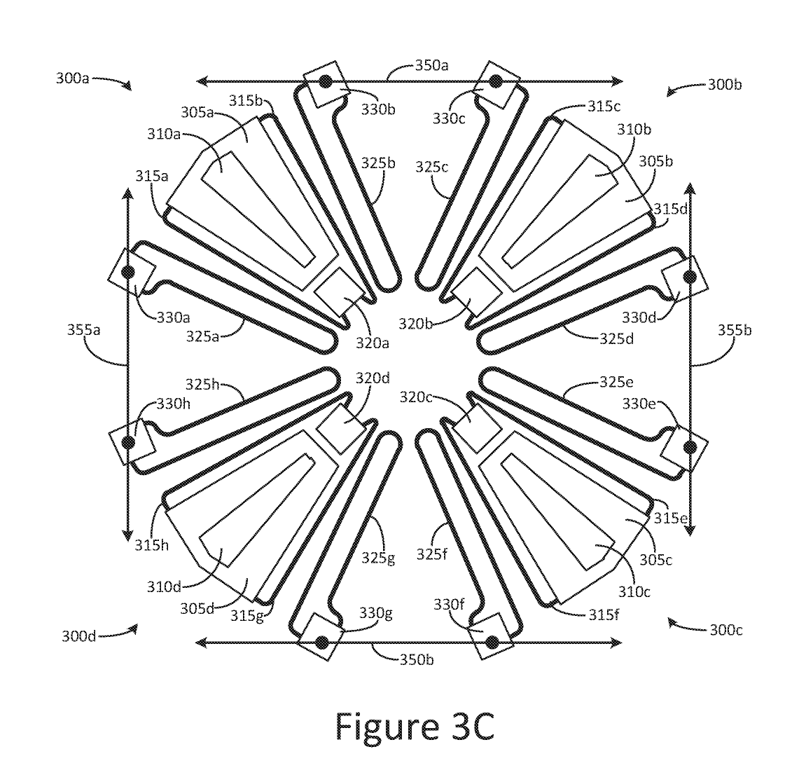

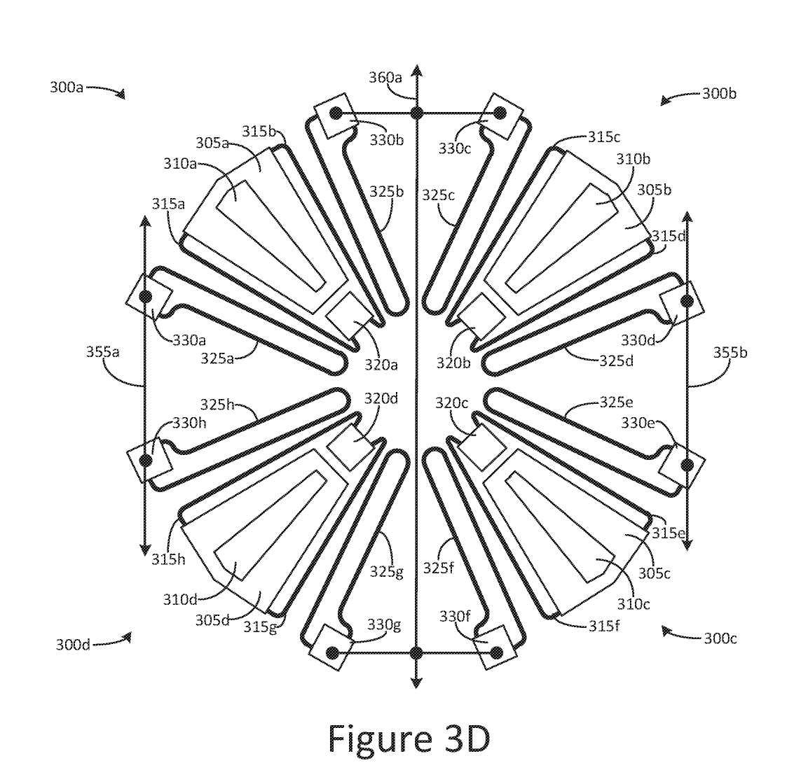

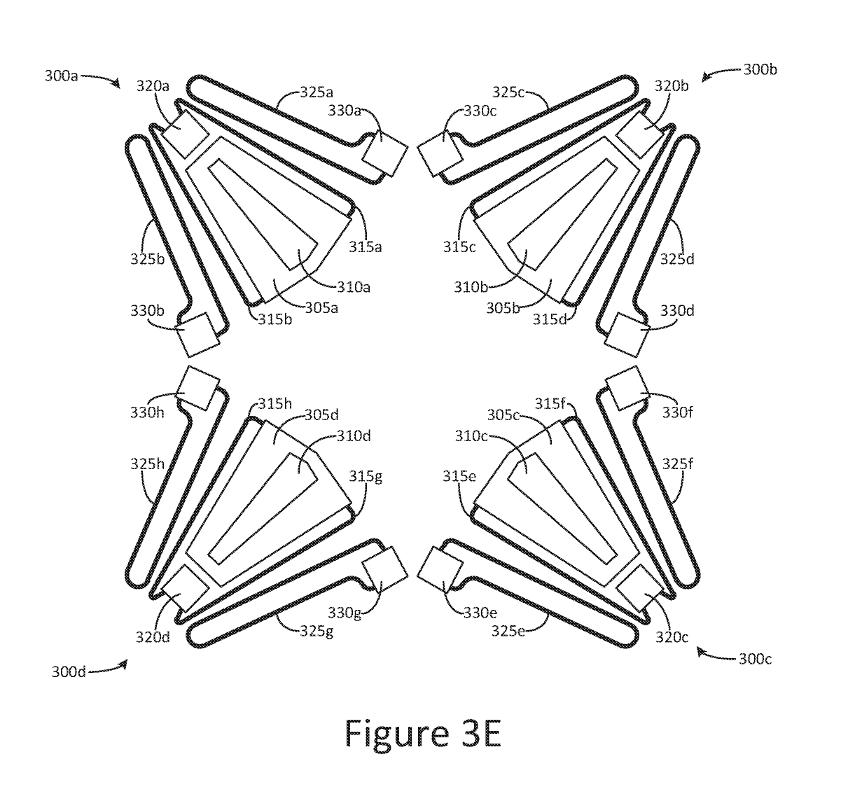

FIG. 3A shows a top view of an example shutter-based light modulator 300. The light modulator 300 includes a shutter 305 and two actuators 311a and 311b (generally referred to as actuators 311). The actuator 311a is an electrostatic actuator including a load beam 315a that is fixed at one end to an edge of the shutter 305 and at another end to a load beam anchor 320. The actuator 311a also includes a drive beam 325a. The drive beam 325a is shaped as a loop arranged at an angle with respect to the shutter 305. A drive beam anchor 330a is coupled to the drive beam 325a. The drive beam anchor 330a mechanically couples the drive beam 325a to an underlying substrate over which the shutter 305 and the actuators 311 are suspended. The load beam anchor 320 couples the load beam 315a to the underlying substrate. The actuators 311 are configured to move the shutter in a plane parallel to the underlying substrate.

The actuator 311b is arranged on a side of the shutter 305 opposite to the side on which the actuator 311a is arranged, and includes components similar to those described above with respect to the actuator 311a. For example, the actuator 311b includes a load beam 315b coupled at one end to the shutter 305 and at the other end to the load beam anchor 320. The actuator 311b also includes a drive beam 325b. The drive beam 325b is coupled to a drive beam anchor 330b, which couples the drive beam 325b to the underlying substrate.

The position of the shutter 305 is controlled by the actuators 311. For example, an actuation voltage can be applied across the drive beam 325a and the load beam 315a of the actuator 311a. The actuation voltage creates an electrostatic force that tends to draw the drive beam 325a and the load beam 315a together. Because the drive beam 325a is fixed to the substrate by the drive beam anchor 330a, the electrostatic force causes the load beam 315a to move towards the drive beam 325a. As the load beam 315a moves, the shutter 305 is pulled rotationally towards the drive beam 325a while remaining substantially parallel to the underlying substrate, because the load beam 315a is fixed to the edge of the shutter 305, as shown in FIG. 3B. The actuator 311b operates in substantially the same manner as the actuator 311a, except that it is configured to cause the shutter 305 to rotate in the opposite direction. Together, the actuators 311 can cause the shutter to move along an arcuate path as indicated by the arrow 313. Therefore, by selectively applying actuation voltages to the actuators 311, the position of the shutter 305 can be controlled. In some implementations, the light modulator 300 may include only a single actuator 311. For example, in some implementations, the light modulator 300 may include the actuator 311a, but not the actuator 311b. In such implementations, the drive beam 325b and the drive beam anchor 330b would not be included in the light modulator 300, although the light modulator still may include the load beam 315b to help support the shutter 305 over the underlying substrate.

The load beam anchor 320 is positioned near the narrow end of the shutter 305, which is referred to in this disclosure as the proximal end of the shutter 305. The wide end of the shutter 305, opposite the narrow end, is referred to in this disclosure as the distal end of the shutter 305. That is, for a given light modulator, the terms “distal” and “proximal” in this disclosure are used relative to a load beam anchor, such as the load beam anchor 320. The load beam electrodes 315a and 315b couple to the shutter 305 at respective points closer to the distal end of the shutter 305 to than to the proximal end of the shutter 305. In some implementations, the load beams 315a and 315b can extend along substantially the entire edge of the shutter 305, as shown in FIG. 3A. This configuration can increase the stability of the shutter 305 relative to other configurations, such as those in which load beams couple to a shutter only at the proximal end. As a result, movement of the shutter 305 out of its intended plane of motion (that is, motion perpendicular to the underlying substrate) can be reduced and, in some implementations, can be substantially eliminated by arranging the load beams 315a and 315b as shown in FIG. 3A. In some implementations, the load beams 315a and 315b may couple to the shutter 305 at a point between the distal end and the proximal end. For example, in some implementations, the load beams 315a and 315b may couple to the shutter 305 at a point between about 50% and about 75% of the distance along the edge from the distal end to the proximal end.

The shutter 305 includes an aperture 310 through which light can pass when the aperture 310 is aligned with an aperture formed in one or more light blocking layers that may be positioned either above or below the shutter 305. Thus, by modulating the position of the shutter 305 using the actuators 311, the amount of light that is permitted to pass through the light modulator 300 can be controlled. In some implementations, this light can represent a single pixel of an image on a display in which the light modulator 300 is incorporated. In some other implementations, the light modulator may be used in connection with other light modulators to implement a single pixel. In practice, a display may include many thousands or millions of light modulators similar to the light modulator 300, in order to form a full image.

In some implementations, the shutter 305 can have a length in the range of about 60 microns to about 120 microns and the aperture 310 can have a length that is about 70% to about 80% of the length of the shutter 305. The proximal end of the shutter can have a width that is shorter than a width of the distal end of the shutter. For example, the distal end of the shutter can have a width in the range of about 10 microns to about 50 microns, and the proximal end of the shutter can have a width in the range of about 5 microns to about 20 microns. In some implementations, the dimensions of the shutter 305 can be selected based in part on the distance between the underlying substrate on which the shutter 305 is formed and another substrate positioned above the shutter 305. This distance is sometimes referred to as the cell gap.

FIG. 3B shows a cross-sectional view of an example display device 301 including the example shutter-based light modulator 300 shown in FIG. 3A. The cross-sectional view of FIG. 3B is taken along the line A-A′ shown in FIG. 3A. The various components of the light modulator 300 are positioned between a rear substrate 304 and a front substrate 316, which can include transparent materials. A rear light blocking layer 342 is positioned on a front side of the rear substrate 304, and a front light blocking layer 340 is positioned on a rear side of the front substrate 316. The rear light blocking layer 342 defines rear apertures 326a and 326b, which are aligned respectively with front apertures 322a and 322b defined through the front light blocking layer 340. Also shown in FIG. 3B is an elevated aperture layer (EAL) 333, which can couple to an anchor such as the load beam anchor 320 (not visible in the cross-sectional view of FIG. 3B). The EAL 333 defines EAL apertures 327a and 327b, each of which is aligned with a respective one of the rear apertures 326a and 326b and a respective one of the front apertures 322a and 322b. It should be noted that the EAL 333 can be an optional component and in some implementations, the display device 301 may not include the EAL 333.

The shutter 305 is shown in an unactuated state. In this example, the actuator 311a serves as a shutter open actuator, and the actuator 311b serves as a shutter close actuator. For example, when the shutter 305 is in an open position, the front aperture 322a, the EAL aperture 327a, and the rear aperture 326a are aligned with the shutter aperture 310, while the optical path between the front aperture 322b, the EAL aperture 327b, and the rear aperture 326b is also unobstructed by the shutter 305. A backlight formed by a light source 319 and a lightguide 321 is positioned behind the rear substrate 304. In some implementations, the lightguide 321 is separated from the rear substrate 304 by a gap 369. In some implementations, the gap 369 can be filled with air. In some other implementations, the gap 369 can be filled with another optically transparent material, including a solid, liquid or gas. In the open position, the shutter 305 can allow light from the lightguide 321 and which passes through the rear apertures 326 to continue to pass towards the front substrate 316 and out of the display device 301 through the front apertures 322. The shutter 305 can be moved into the open position by applying a voltage across the actuator 311a. In some implementations, circuit elements, such as transistors, that are used for generating or transmitting actuation voltages can be included within a backplane layer (not shown) formed over the rear substrate 304. Voltages can be transmitted from the backplane to the drive beams 325a and 325b through the drive beam anchors 330a and 330b, respectively. Voltages can be transmitted from the backplane to the load beams 315a and 315b through the load beam anchor 320 shown in FIG. 3A.

The light modulator 300 is fabricated in what is referred to as a “MEMS-down” configuration, in which the load beam anchor 320 and the drive beam anchors 330a and 330b are coupled to the front substrate 316 and support the other components of the light modulator 300 over the front substrate 316. In some other implementations, the light modulator can instead be fabricated in a “MEMS-up” configuration, in which the load beam anchor 320 and the drive beam anchors 330a and 330b are coupled to the rear substrate 304 and support the other components of the light modulator 300 over the rear substrate 304.

In some implementations, the dimensions of various components of the display device 301 can be selected to improve the optical properties of the display device 301. For example, to ensure that light is blocked when the shutter 305 is in a closed state, the width of the light blocking portions of the shutter 305 on either side of the shutter aperture 310 (labeled D1 in FIG. 3B) can be selected to be greater than the width of the shutter aperture 310 (labeled D2 in FIG. 3B). In some implementations, the width of the light blocking portions of the shutter 305 also can be selected to be larger than the distance between the front substrate 316 and the rear substrate 304, which is sometimes referred to as the cell gap, in order to avoid light leakage from the rear aperture 326a to the front aperture 322b, or from the rear aperture 326b to the front aperture 322a.

FIG. 3C shows a top view of an example array of shutter-based light modulators 300a-300d having drive beam anchors 330 wired according to a first example wiring pattern. Each of the light modulators 300a-300d is substantially similar to the light modulator 300 shown in FIG. 3A, and like reference numerals refer to like elements. For example, the light modulator 300a includes a shutter 305a with a shutter aperture 310a. Load beams 315a and 315b couple at one end to a load beam anchor 320a and at another end to the shutter 305a. Drive beams 325a and 325b couple to drive beam anchors 330a and 330b, respectively. Similarly, the light modulator 300b includes a shutter 305b with a shutter aperture 310b. Load beams 315c and 315d couple at one end to a load beam anchor 320b and at another end to the shutter 305b. Drive beams 325c and 325d couple to drive beam anchors 330c and 330d, respectively. Likewise, the light modulator 300c includes a shutter 305c with a shutter aperture 310c. Load beams 315e and 315f couple at one end to a load beam anchor 320c and at another end to the shutter 305c. Drive beams 325e and 325f couple to drive beam anchors 330e and 330f, respectively. Finally, the light modulator 300d includes a shutter 305d with a shutter aperture 310d. Load beams 315g and 315h couple at one end to a load beam anchor 320d and at another end to the shutter 305d. Drive beams 325g and 325h couple to drive beam anchors 330g and 330h, respectively.

The light modulators 300a-300d are arranged in a radially symmetric fashion about the center of the array. As shown in FIG. 3C, this arrangement is spatially efficient and results in relatively little unused space on the underlying substrate. While the array shown in FIG. 3C includes four light modulators 300a-300d, it should be understood that other arrays may include different numbers of light modulators 300. For example, an array may include two, three, four, or more light modulators. In some implementations, the light modulators 300 can be arranged in a radially symmetric fashion regardless of the total number of light modulators 300 in the array. Radial symmetry can be preserved by arranging the array such that the angle formed by each pair of adjacent light modulators 300 is substantially the same. In general, the angle between adjacent light modulators 300 can be measured as the angle formed by the centerlines of their respective shutters when their respective shutters are in an unactuated state. The array shown in FIG. 3C includes four light modulators 300a-300d, and therefore the angle formed between adjacent light modulators 300 is about 90 degrees.

In some implementations, the angle between adjacent light modulators 300 in an array can change based on the number of light modulators 300 in the array. For example, in a radially symmetric array of three light modulators 300, the angle between each pair of adjacent light modulators 300 can be about 120 degrees. In some implementations, laying out an array of light modulators 300 such that each pair of adjacent light modulators 300 is arranged at an angle with respect to one another can improve the uniformity of viewing angles for a display device. For example, a given light modulator 300 may have non-uniform angular distribution of light, because the shutter aperture 310 is longer along the length of the shutter 305 than across its width. As a result, light may escape from a light modulator at higher angles along a direction parallel to the length of the shutter 305 than along a direction parallel to the width of the shutter 305. Thus, the angular distribution of light for a light modulator 300 depends in part on the orientation of the light modulator 300. By varying the orientation of light modulators 300 within an array, the total angular distribution of light also can be varied, which can result in more uniform viewing angles.

The array of light modulators 300 shown in FIG. 3C also can allow for drive beam anchors 330 of adjacent light modulators to share an electrical connection. For example, in some implementations, a first drive beam anchor 330 of each light modulator 300 may be maintained at a high voltage, while a second drive beam anchor 330 of each light modulator 300 may be maintained at a low voltage. The voltage applied at the load beam anchor 320 of each light modulator 300 can be changed according to image data in order to cause the shutter 305 to move towards one of the first and second drive beam anchors 330. In such implementations, electrically connecting drive beam anchors 330 of adjacent light modulators 300 can help to simplify the wiring pattern used in a backplane of the display device. In the example of FIG. 3C, the drive beam anchor 330b of the light modulator 300a is electrically connected to the drive beam anchor 330c of the light modulator 300b by the electrical interconnect 350a. Similarly, the drive beam anchor 330f of the light modulator 300c is electrically connected to the drive beam anchor 330g of the light modulator 300d by the electrical interconnect 350b. In some implementations, the interconnects 350a and 350b can be configured to deliver a first common voltage level to their respective drive beam anchors 330. In addition, the interconnects 350a and 350b can be configured to extend beyond the array shown in FIG. 3C. For example, each of the interconnects 350a and 350b may extend across substantially the entire display and may electrically connect the drive beam anchors 330 of an entire row of light modulators 300.

Likewise, the drive beam anchor 330a of the light modulator 300a is electrically connected to the drive beam anchor 330h of the light modulator 300d by the electrical interconnect 355a, and the drive beam anchor 330d of the light modulator 300b is electrically connected to the drive beam anchor 330e of the light modulator 300c by the electrical interconnect 355b. In some implementations, the interconnects 350a and 350b can be configured to deliver a second common voltage level, different from the first common voltage level, to their respective drive beam anchors 330. Moreover, like the interconnects 350a and 350b, the interconnects 355a and 355b can be configured to extend beyond the array shown in FIG. 3C. For example, each of the interconnects 355a and 355b may extend across substantially the entire display and may electrically connect the drive beam anchors 330 of an entire column of light modulators 300.

FIG. 3D shows a top view of the example array of shutter-based light modulators 300a-300d shown in FIG. 3C having drive beam anchors 330 wired according to a second example wiring pattern. The layout of the light modulators 300a-300d is identical to the layout shown in FIG. 3C, and only the wiring pattern is changed. In FIG. 3D, the drive beam anchor 330b of the light modulator 300a, the drive beam anchor 330c of the light modulator 300b, the drive beam anchor 330f of the light modulator 300c, and the drive beam anchor 330g of the light modulator 300d are all electrically connected by the electrical interconnect 360a. The electrical interconnect 360a also can extend across the display to electrically connect drive beam anchors of other light modulators 300. As in FIG. 3C, the drive beam anchor 330a of the light modulator 300a is electrically connected to the drive beam anchor 330h of the light modulator 300d by the electrical interconnect 355a, and the drive beam anchor 330d of the light modulator 300b is electrically connected to the drive beam anchor 330e of the light modulator 300c by the electrical interconnect 355b. In such an implementation, the electrical interconnects 355a, 355b, and 360a run parallel to one another in the vertical axis as shown in FIG. 3D. Due to the rotational symmetry of the layout of the light modulators 300, in some implementations the electrical interconnects 355a, 355b, and 360a can be configured to run parallel to the horizontal axis instead of the vertical axis.

FIG. 3E shows a top view of another example array of shutter-based light modulators 300a-300d. Like the array shown in FIGS. 3C and 3D, the array of light modulators 300a-300d shown in FIG. 3E exhibits radial symmetry. The arrangement of light modulators 300a-300d in FIG. 3E differs from that of FIGS. 3C and 3D in that each light modulator 300 is facing inwards towards the center of the array. That is, the distal ends of the shutters 305 of adjacent light modulators 300 are closer than their proximal ends in the array shown in FIG. 3E, while the proximal ends of the shutters 305 of adjacent light modulators 300 are closer than their distal ends in the array shown in FIGS. 3C and 3D. However, because the array of light modulators 300 shown in shown in FIG. 3E is radially symmetric, many of the benefits discussed above in connection with the arrays of light modulators 300 shown in FIGS. 3C and 3D also apply to the array of light modulators 300 shown in FIG. 3E. For example, the array of light modulators 300 shown in FIG. 3E can have improved viewing angle uniformity and shared electrical connections between drive beam anchors 330 of adjacent light modulators 300.

In some implementations, the light modulators 300a-300d (generally referred to as light modulators 300) arranged as shown in any of FIGS. 3C-3E together can form a single pixel of a display device, such as the display device 301 shown in FIG. 3B. For example, a display device can be configured to process image data as a stream of intensity values for each of several component colors that make up each pixel, such as red, green, blue, and white (RGBW). Each of the light modulators 300a-300d can be associated with a unique component color. Thus, in one example, for a given image frame, the light modulator 300a can be configured to output light based on the intensity value associated with the color red, the light modulator 300b can be configured to output light based on the intensity value associated with the color green, the light modulator 300c can be configured to output light based on the intensity value associated with the color blue, and the light modulator 300d can be configured to output light based on the intensity value associated with the color white. In such an implementation, each light modulator may be associated with a color filter for its respective component color. The color filter can be positioned, for example, in the optical path through the shutter aperture 310 when the shutter 305 is in an open position.

In some implementations, the light modulators 300 of the sub pixel array can be used to implement an area division greyscale scheme. Together, the light modulators 300 can form a pixel that can have at least four different brightness values. For example, to produce the highest possible brightness, all of the light modulators 300 can be moved into an open state. To produce the lowest possible brightness, all of the light modulators 300 can be moved into a closed state. Three intermediate states are also possible, for example, by moving one, two, or three of the light modulators 300 into open states. In some other implementations, the sub pixel array shown in FIG. 3B can be used to provide redundancy if one or more of the light modulators 300 fails.

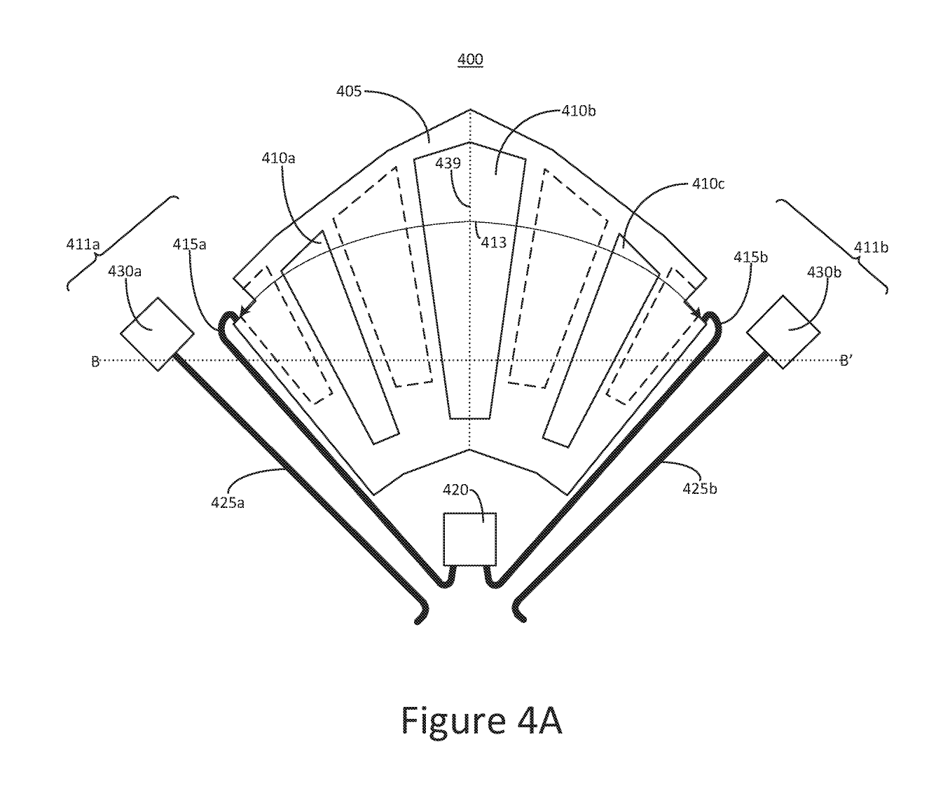

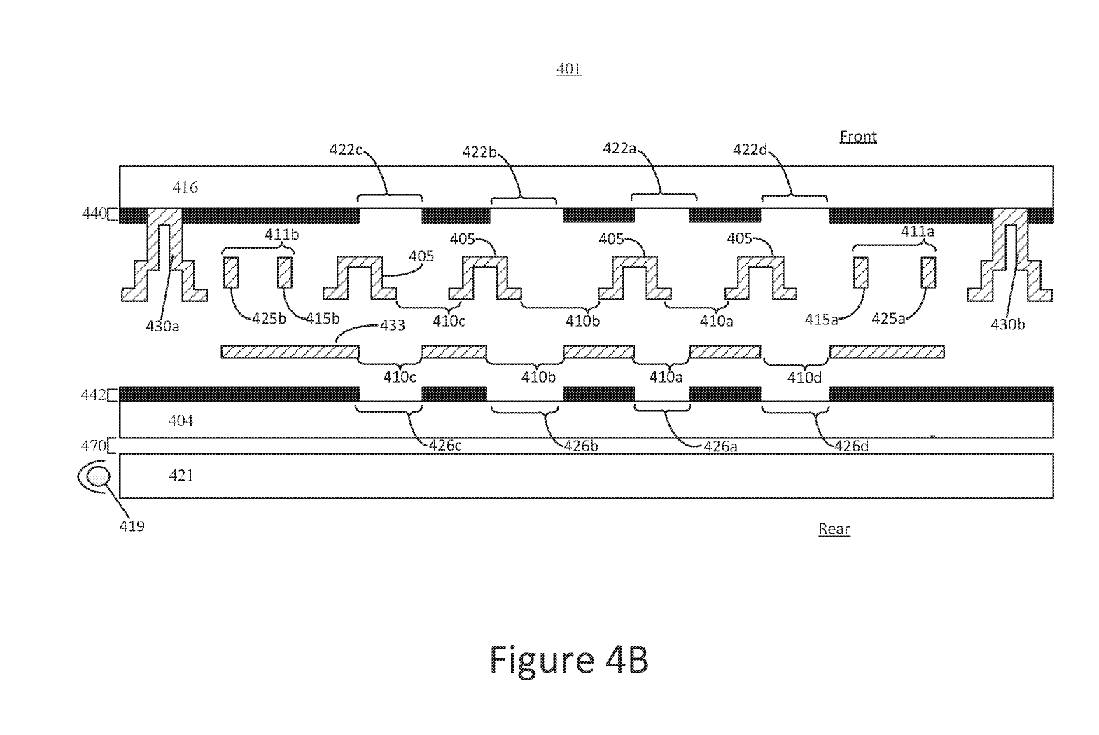

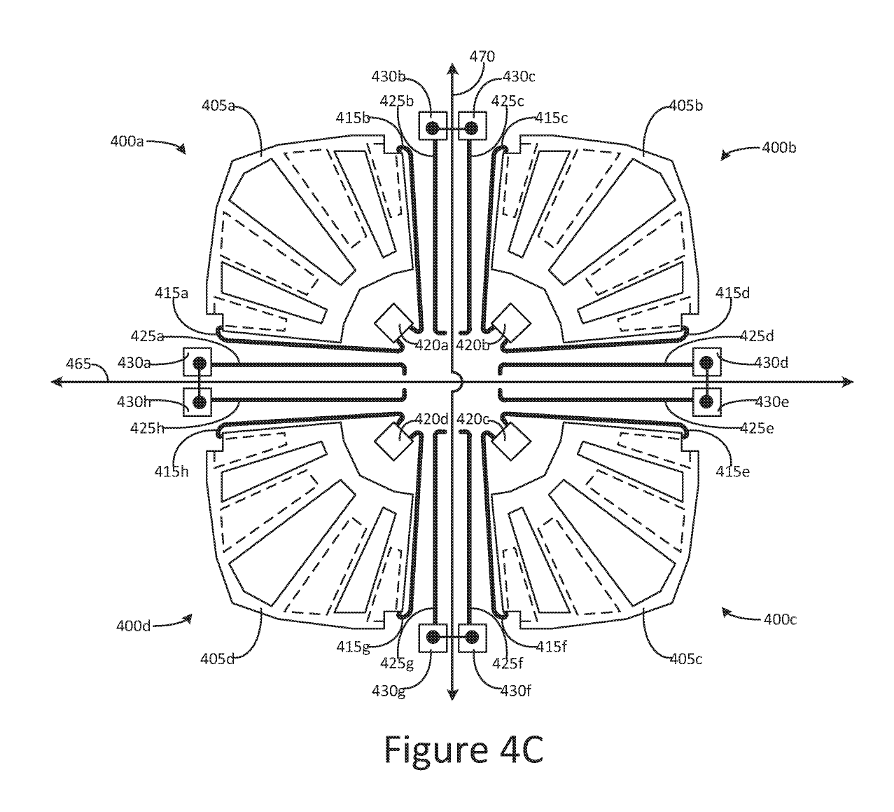

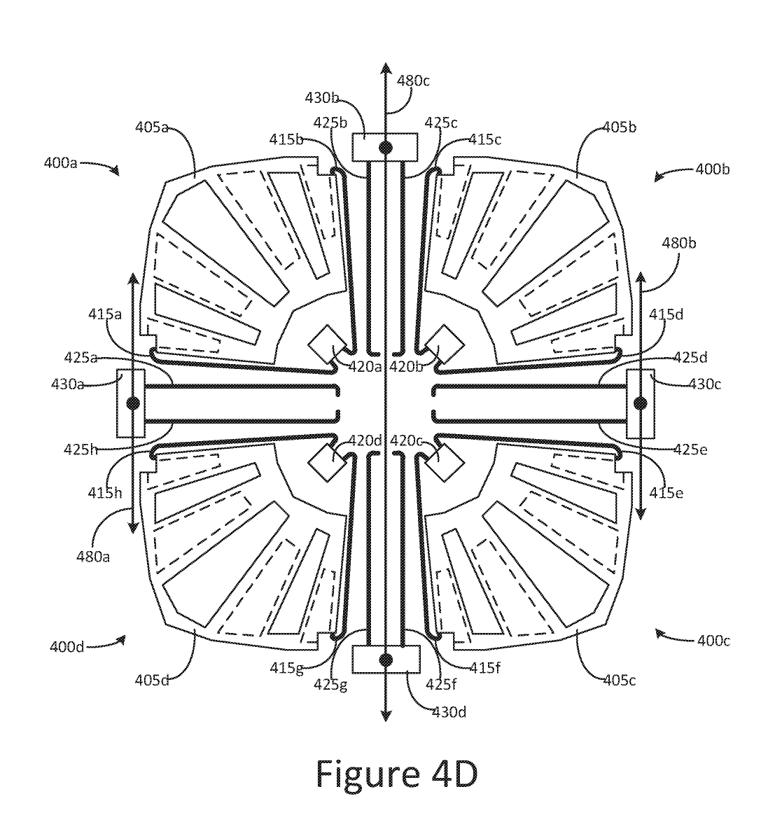

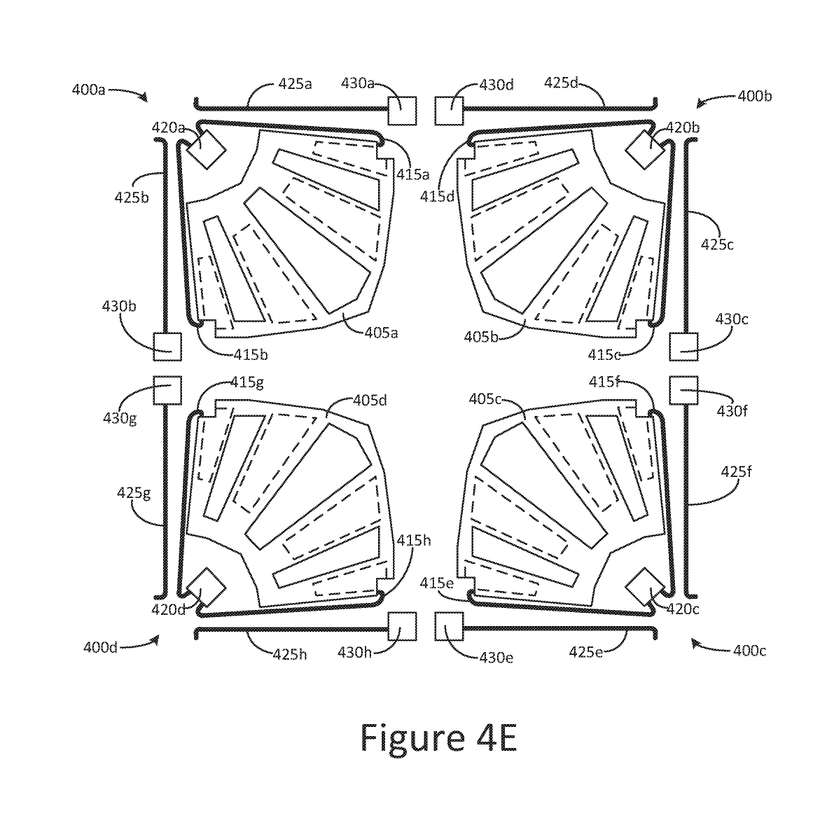

FIG. 4A shows a top view of another example shutter-based light modulator 400. The light modulator 400 is similar to the light modulator 300 shown in FIGS. 3A and 3B, and like reference numerals refer to like elements. For example, the light modulator 400 includes a shutter 405 and two actuators 411a and 411b (generally referred to as actuators 411). The actuator 411a is an electrostatic actuator including a load beam 415a that is fixed at one end to an edge of the shutter 405 and at another end to a load beam anchor 420. The actuator 411a also includes a drive beam 425a. A drive beam anchor 430a is coupled to the drive beam 425a. The drive beam anchor 430a mechanically couples the drive beam 425a to an underlying substrate over which the shutter 405 and the actuators 411 are suspended. The load beam anchor 420 couples the load beam 415a to the underlying substrate. The actuators 411 are configured to move the shutter rotationally in a plane parallel to the underlying substrate.

The actuator 411b is arranged on a side of the shutter 405 opposite to the side on which the actuator 411a is arranged, and includes components similar to those described above with respect to the actuator 411a. For example, the actuator 411b includes a load beam 415b coupled at one end to the shutter 405 and at the other end to the load beam anchor 420. The actuator 411b also includes a drive beam 425b. The drive beam 425b is coupled to a drive beam anchor 430b, which couples the drive beam 425b to the underlying substrate. The position of the shutter 405 can be controlled by the actuators 411 in a manner similar to that discussed above in connection with FIGS. 3A and 3B.

Unlike the light modulator 300 shown in FIG. 3A, the light modulator 400 includes three shutter apertures 410a-410c (generally referred to as shutter apertures 410). In some implementations, light blocking layers positioned either below or above the shutter 405 can include apertures aligned with the shutter apertures 410 when the shutter 410 is in an open position. The inclusion of more than one shutter aperture 410 can help to increase the aperture ratio, which can allow a larger amount of light to pass through the light modulator 400, thereby increasing the brightness of a display device incorporating the light modulator 400. In some implementations, the shape of shutter 405 also can be selected to allow for a larger aperture ratio. For example, as shown in FIG. 4A, the shutter 405 is shaped such that a centerline 439 connecting its distal and proximal ends is longer than each of the left and right edges of the shutter 405. As a result, a substantial portion of the shutter 405 can extend beyond the arc 413 passing through the points at which the load beams 415a and 415b connect to the shutter 405. The size of the shutter 405 can therefore be increased without increasing the length of the load beams 415a and 415b. Also as a result of this shutter shape, the central shutter aperture 410b can be made substantially larger than the shutter apertures 410a and 410c.

The broken lines on the shutter 405 indicate portions of the shutter 405 that can be depressed or raised relative to the portions of the shutter 405 not surrounded by the broken lines. Thus, the shutter 405 can have a three-dimensional shape that extends out of the intended plane of motion of the shutter 405. In some implementations, such a shape can improve the structural rigidity of the shutter 405, making it less likely to deform out of its plane of intended motion. The three-dimensional shape of the shutter 405 is further illustrated in FIG. 4B.

FIG. 4B shows a cross-sectional view of an example display device 401 including the example shutter-based light modulator 400 shown in FIG. 4A. The cross-sectional view of FIG. 4B is taken along the line B-B′ shown in FIG. 4A. The display device 401 is similar to the display device 301 shown in FIG. 3B, and like reference numerals refer to like elements. For example, the various components of the light modulator 400 are positioned between a rear substrate 404 and a front substrate 416. A rear light blocking layer 442 is positioned on a front side of the rear substrate 404, and a front light blocking layer 440 is positioned on a rear side of the front substrate 416. The rear light blocking layer 442 defines rear apertures 426a-426d, which are aligned respectively with front apertures 422a-422d defined through the front light blocking layer 440. Also shown in FIG. 4B is an EAL 433, which can be coupled to another anchor such as the load beam anchor 420 (not shown in the cross-sectional view of FIG. 4B). The EAL 433 defines EAL apertures 427a-427d, each of which is aligned with a respective one of the rear apertures 426a-426d and a respective one of the front apertures 422a-422d. It should be noted that the EAL 433 can be an optional component and in some implementations, the display device 401 may not include the EAL 433.

The shutter 405 is shown in an unactuated state. In this example, the actuator 411b serves as a shutter open actuator, and the actuator 411a serves as a shutter close actuator. For example, when the shutter 405 is in an open position, the front apertures 422a-426c, the EAL apertures 427a-427c, and the rear apertures 426a-426c are aligned with the shutter apertures 410a-410c, respectively, while the optical path between the front aperture 422d, the EAL aperture 427d, and the rear aperture 426d is also unobstructed by the shutter 410. A backlight formed by a light source 419 and a lightguide 421 is positioned behind the rear substrate 404. In some implementations, the lightguide 421 is separated from the rear substrate 404 by a gap 469. In some implementations, the gap 470 can be filled with air. In some other implementations, the gap 470 can be filled with another optically transparent material, including a solid, liquid or gas. In the open position, the shutter 405 can allow the light exiting the lightguide 421 and passing through the rear apertures 426 to continue to pass towards the front substrate 416 and out of the display device 401 through the front apertures 422. The shutter 405 can be moved into the open position by applying a voltage across the actuator 411b. In some implementations, circuit elements, such as transistors, that are used for generating or transmitting actuation voltages can be included within a backplane layer (not shown) formed over the front substrate 416. Voltages can be transmitted from the backplane to the drive beams 425a and 425b through the drive beam anchors 430a and 430b, respectively. Voltages can be transmitted from the backplane to the load beams 415a and 415b through the load beam anchor 420 shown in FIG. 4A.

The light modulator 400 is fabricated in what is referred to as a “MEMS-down” configuration, in which the load beam anchor 420 and the drive beam anchors 430a and 430b are coupled to the front substrate 416 and support the other components of the light modulator 400 over the front substrate 416. In some other implementations, the light modulator can instead be fabricated in a “MEMS-up” configuration in which the load beam anchor 420 and the drive beam anchors 430a and 430b are coupled to the rear substrate 404 and support the other components of the light modulator 400 over the rear substrate 404.

FIG. 4C shows a top view of an example array of shutter-based light modulators 400a-400d having drive beam anchors 430 wired according to a first example wiring pattern. Each of the light modulators 400a-400d is substantially similar to the light modulator 400 shown in FIG. 4A, and like reference numerals refer to like elements. For example, the light modulator 400a includes a shutter 405a. Load beams 415a and 415b couple at one end to a load beam anchor 420a and at another end to the shutter 405a. Drive beams 425a and 425b couple to drive beam anchors 430a and 430b, respectively. Similarly, the light modulator 400b includes a shutter 405b. Load beams 415c and 415d couple at one end to a load beam anchor 420b and at another end to the shutter 405b. Drive beams 425c and 425d couple to drive beam anchors 430c and 430d, respectively. Likewise, the light modulator 400c includes a shutter 405c with a shutter aperture 410c. Load beams 415e and 415f couple at one end to a load beam anchor 420c and at another end to the shutter 405c. Drive beams 425e and 425f couple to drive beam anchors 430e and 430f, respectively. Finally, the light modulator 400d includes a shutter 405d with a shutter aperture 410d. Load beams 415g and 415h couple at one end to a load beam anchor 420d and at another end to the shutter 405d. Drive beams 425g and 425h couple to drive beam anchors 430g and 430h, respectively.

In some implementations, the light modulators 400a-400d (generally referred to as light modulators 400) together can form a single pixel of a display device, in a manner similar to that described above in connection with FIG. 3C. The light modulators 400a-400d are arranged in a radially symmetric fashion about the center of the array. As shown in FIG. 4C, this arrangement is spatially efficient and results in relatively little unused space on the underlying substrate. While the array shown in FIG. 4C includes four light modulators 400a-400d, it should be understood that other arrays may include different numbers of light modulators 300. For example, an array may include two, three, four, or more light modulators 400. In some implementations, the light modulators 400 can be arranged in a radially symmetric fashion regardless of the total number of light modulators 400 in the array. In some implementations, laying out an array of light modulators 400 in a radially symmetric fashion can improve the uniformity of viewing angles for a display device, as discussed above in connection with FIG. 3C.

The array of light modulators 400 shown in FIG. 4C also can allow for drive beam anchors 430 of adjacent light modulators 400 to share an electrical connection. For example, in some implementations, a first drive beam anchor 430 of each light modulator 400 may be maintained at a high voltage, while a second drive beam anchor 430 of each light modulator 400 may be maintained at a low voltage. In the example of FIG. 4C, the drive beam anchor 430b of the light modulator 400a, the drive beam anchor 430c of the light modulator 400b, the drive beam anchor 430f of the light modulator 400c, and the drive beam anchor 430g of the light modulator 400d are all electrically connected by the electrical interconnect 470. In some implementations, the interconnect 470 can be configured to deliver a first common voltage level to these drive beam anchors 430. In addition, the interconnect 470 can be configured to extend beyond the array shown in FIG. 4C. For example, the interconnect 470 may extend across substantially the entire display and may electrically connect the drive beam anchors 430 of an entire column of light modulators 400.

Likewise, the drive beam anchor 430a of the light modulator 400a, the drive beam anchor 430h of the light modulator 400d, the drive beam anchor 430d of the light modulator 400b, and the drive beam anchor 430e of the light modulator 400c are all electrically connected by the electrical interconnect 465. In some implementations, the interconnect 470 can be configured to deliver a second common voltage level, different from the first common voltage level, to these drive beam anchors 430. Like the interconnect 470, the interconnect 465 can be configured to extend beyond the array shown in FIG. 4C. For example, the interconnect 465 may extend across substantially the entire display and may electrically connect the drive beam anchors 430 of an entire row of light modulators 400.

FIG. 4D shows a top view of the example array of shutter-based light modulators 400a-400d shown in FIG. 4C having drive beam anchors 430 wired according to a second example wiring pattern. The layout of the light modulators 400a-400d is similar to the layout shown in FIG. 4C, but the wiring pattern is changed. The array shown in FIG. 4D also differs from that shown in FIG. 4C in that the each pair of adjacent light modulators includes a shared drive beam anchor. In particular, the drive beam anchor 430a is shared by the drive beam 425a of the light modulator 400a and by the drive beam 425h of the light modulator 400d, the drive beam anchor 430b is shared by the drive beam 425b of the light modulator 400a and by the drive beam 425c of the light modulator 400b, the drive beam anchor 430c is shared by the drive beam 425d of the light modulator 400b and by the drive beam 425e of the light modulator 400c, the drive beam anchor 430d is shared by the drive beam 425f of the light modulator 400c and by the drive beam 425g of the light modulator 400d.

The drive beam anchor 430a is electrically connected to the electrical interconnect 480a. The drive beam anchor 430c is electrically connected to the electrical interconnect 480b. The electrical interconnects 480a and 480b can extend across the display to electrically connect drive beam anchors 430 of other light modulators 400. The drive beam anchors 430b and 430d are both electrically connected by the electrical interconnect 480c, which also can extend across the display to electrically connect drive beam anchors 430 of other light modulators 400. In this implementation, the electrical interconnects 480a, 480b, and 480c run parallel to one another in the vertical axis direction as shown in FIG. 4D. Due to the rotational symmetry of the layout of the light modulators 400, in some implementations the electrical interconnects 480a, 480b, and 480c can be configured to run parallel to the horizontal axis instead of the vertical axis.

FIG. 4E shows a top view of another example array of shutter-based light modulators 400a-400d. Like the array shown in FIGS. 4C and 4D, the array of light modulators 400a-400d shown in FIG. 4E exhibits radial symmetry. The arrangement of light modulators 400a-400d in FIG. 4E differs from that of FIGS. 4C and 4D in that each light modulator 400 is facing inwards towards the center of the array. That is, the distal ends of the shutters 405 of adjacent light modulators 400 are closer than their proximal ends in the array shown in FIG. 4E, while the proximal ends of the shutter 405 of adjacent light modulators 400 are closer than their distal ends in the array shown in FIGS. 4C and 4D. However, because the array of light modulators 400 shown in shown in FIG. 4E is radially symmetric, many of the benefits discussed above in connection with the arrays of light modulators 400 shown in FIGS. 4C and 4D also apply to the array of light modulators 400 shown in FIG. 4E. For example, the array of light modulators 400 shown in FIG. 4E can have improved viewing angle uniformity and shared electrical connections between drive beam anchors 430 of adjacent light modulators 400.

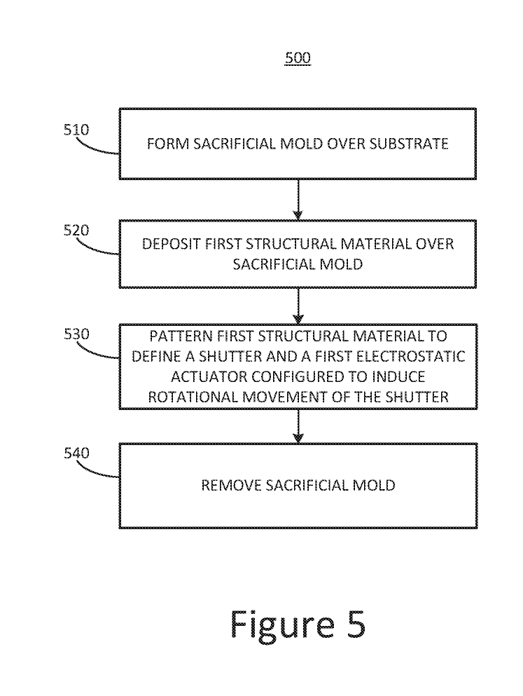

FIG. 5 shows a flow chart of an example process 500 for manufacturing a display device. In some implementations, the process 500 can be used to form a display device including light modulators similar to the light modulator 300 shown in FIG. 3A or the light modulator 400 shown in FIG. 4A. In brief overview, the process 500 includes forming a sacrificial mold over a substrate (stage 510), depositing a first structural material over the sacrificial mold (stage 520), patterning the first structural material to define a shutter and at least a first electrostatic actuator configured to induce rotational movement of the shutter (stage 530), and removing the sacrificial mold (stage 540).

Referring again to FIG. 5, the process 500 includes forming a sacrificial mold over a substrate (stage 510). For example, in some implementations, a multi-level mold made of sacrificial material, such as a photodefineable resin, can be formed using photolithography. The mold can include surfaces that are parallel to the primary plane of the substrate, and sidewalls that are normal to the primary plane of the substrate. The inclusion of a mold made from multiple levels of sacrificial material can allow for the fabrication of components having three-dimensional structures, similar to the shutter 405 shown in FIGS. 4A and 4B.

The process 500 includes depositing a first structural material over the sacrificial mold (stage 520). One or more layers of structural material, such as conductive metals or semiconductors, can be deposited over the mold in one or more conformal deposition processes, such as sputtering, physical vapor deposition (PVD), electroplating, chemical vapor deposition (CVD), plasma-enhanced chemical vapor deposition (PECVD), or atomic level deposition (ALD). Specific examples of suitable structural materials include, without limitation, amorphous silicon (a-Si), titanium (Ti), aluminum (Al), and molybdenum (Mo). In some other implementations, the structural material can include multiple layers of metal and dielectric films. For example, the structural material can include layers of silicon nitride (SiNx) and Ti or layers of silicon dioxide (SiO₂) and Ti. In some other implementations, the structural material can include metal layers such as Ti or Al positioned between a layer of SiNx and a layer of a-Si.

The process 500 includes patterning the first structural material to define a shutter and at least a first electrostatic actuator configured to induce rotational movement of the shutter (stage 530). In some implementations, the process 500 also can include patterning the first structural material to define a second electrostatic actuator. In some implementations, the first structural material can be patterned using one or more etch processes. In some implementations, an anisotropic etch can be used to remove undesired portions of the structural material deposited on surfaces of the mold that are parallel to the primary plane of the mold, while leaving structural material on the sidewalls. The material that remains on the sidewalls can form, for example, the drive beams 325a and 325b, as well as the load beams 315a and 315b, of the light modulator 300 shown in FIGS. 3A and 3B, or the drive beams 425a and 425b and the load beams 415a and 415b of the light modulator 400 shown in FIGS. 4A and 4B. In some implementations, it also can form the vertical surfaces of other components such as the vertical sidewalls included in the shutter 405 of the light modulator 400 shown in FIGS. 4A and 4B. In some implementations, an additional etch step can be applied to remove one or more layers of material from the drive beams and the load beams, reducing their thickness and increasing their mechanical compliance. In some implementations, the drive beams and the load beams can range from about 0.1 microns to about 1.5 microns thick, and are between about 2 and about 10 microns in height. In some implementations, the load beams may have a length of less than about 100 microns.

In some implementations, additional levels of sacrificial material can be deposited and patterned to form molds for other components. For example, the form an EAL such as the EAL 333 shown in FIG. 3B or the EAL 433 shown in FIG. 4B, an additional sacrificial mold can be formed over the patterned shutter, drive beams, and load beams. A second layer of structural material can be deposited over the second sacrificial mold and patterned to define the EAL. The sacrificial mold can then be removed (stage 540) through a release process, freeing the components of the light modulator to move.

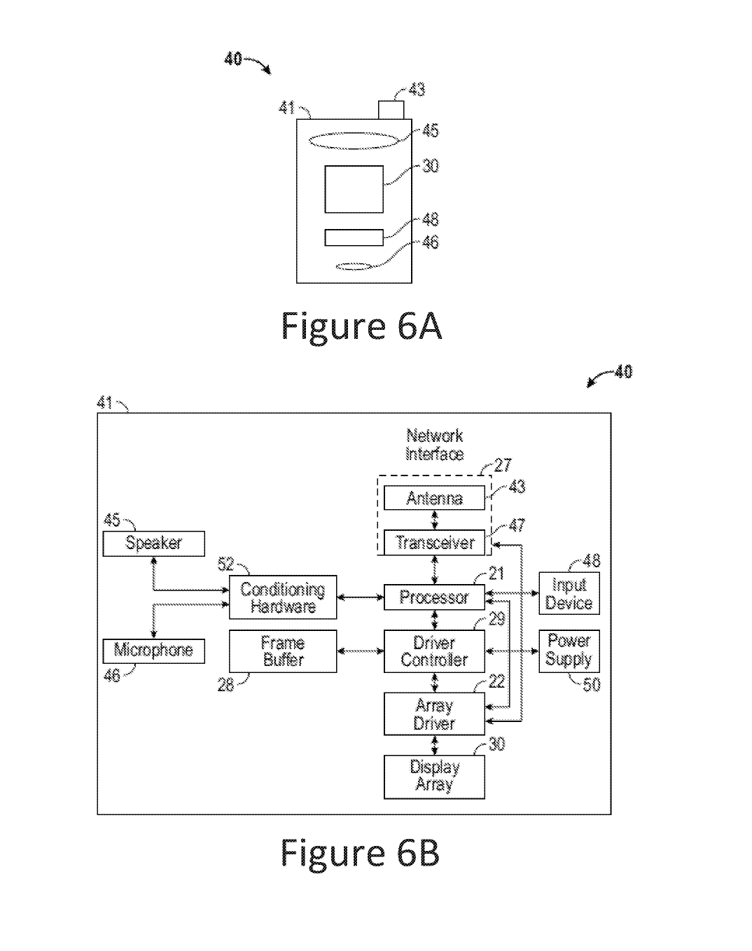

FIGS. 6A and 6B show system block diagrams of an example display device 40 that includes a plurality of display elements. The display device 40 can be, for example, a smart phone, a cellular or mobile telephone. However, the same components of the display device 40 or slight variations thereof are also illustrative of various types of display devices such as televisions, computers, tablets, e-readers, hand-held devices and portable media devices.

The display device 40 includes a housing 41, a display 30, an antenna 43, a speaker 45, an input device 48 and a microphone 46. The housing 41 can be formed from any of a variety of manufacturing processes, including injection molding, and vacuum forming. In addition, the housing 41 may be made from any of a variety of materials, including, but not limited to: plastic, metal, glass, rubber and ceramic, or a combination thereof. The housing 41 can include removable portions (not shown) that may be interchanged with other removable portions of different color, or containing different logos, pictures, or symbols.

The display 30 may be any of a variety of displays, including a bi-stable or analog display, as described herein. The display 30 also can be capable of including a flat-panel display, such as plasma, electroluminescent (EL) displays, OLED, super twisted nematic (STN) display, LCD, or thin-film transistor (TFT) LCD, or a non-flat-panel display, such as a cathode ray tube (CRT) or other tube device. In addition, the display 30 can include a mechanical light modulator-based display, as described herein.

The components of the display device 40 are schematically illustrated in FIG. 6B. The display device 40 includes a housing 41 and can include additional components at least partially enclosed therein. For example, the display device 40 includes a network interface 27 that includes an antenna 43 which can be coupled to a transceiver 47. The network interface 27 may be a source for image data that could be displayed on the display device 40. Accordingly, the network interface 27 is one example of an image source module, but the processor 21 and the input device 48 also may serve as an image source module. The transceiver 47 is connected to a processor 21, which is connected to conditioning hardware 52. The conditioning hardware 52 may be configured to condition a signal (such as filter or otherwise manipulate a signal). The conditioning hardware 52 can be connected to a speaker 45 and a microphone 46. The processor 21 also can be connected to an input device 48 and a driver controller 29. The driver controller 29 can be coupled to a frame buffer 28, and to an array driver 22, which in turn can be coupled to a display array 30. One or more elements in the display device 40, including elements not specifically depicted in FIG. 6A, can be capable of functioning as a memory device and be capable of communicating with the processor 21. In some implementations, a power supply 50 can provide power to substantially all components in the particular display device 40 design.

The network interface 27 includes the antenna 43 and the transceiver 47 so that the display device 40 can communicate with one or more devices over a network. The network interface 27 also may have some processing capabilities to relieve, for example, data processing requirements of the processor 21. The antenna 43 can transmit and receive signals. In some implementations, the antenna 43 transmits and receives RF signals according to any of the IEEE 16.11 standards, or any of the IEEE 802.11 standards. In some other implementations, the antenna 43 transmits and receives RF signals according to the Bluetooth® standard. In the case of a cellular telephone, the antenna 43 can be designed to receive code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1×EV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), AMPS, or other known signals that are used to communicate within a wireless network, such as a system utilizing 3G, 4G or 5G, or further implementations thereof, technology. The transceiver 47 can pre-process the signals received from the antenna 43 so that they may be received by and further manipulated by the processor 21. The transceiver 47 also can process signals received from the processor 21 so that they may be transmitted from the display device 40 via the antenna 43.

In some implementations, the transceiver 47 can be replaced by a receiver. In addition, in some implementations, the network interface 27 can be replaced by an image source, which can store or generate image data to be sent to the processor 21. The processor 21 can control the overall operation of the display device 40. The processor 21 receives data, such as compressed image data from the network interface 27 or an image source, and processes the data into raw image data or into a format that can be readily processed into raw image data. The processor 21 can send the processed data to the driver controller 29 or to the frame buffer 28 for storage. Raw data typically refers to the information that identifies the image characteristics at each location within an image. For example, such image characteristics can include color, saturation and gray-scale level.

The processor 21 can include a microcontroller, CPU, or logic unit to control operation of the display device 40. The conditioning hardware 52 may include amplifiers and filters for transmitting signals to the speaker 45, and for receiving signals from the microphone 46. The conditioning hardware 52 may be discrete components within the display device 40, or may be incorporated within the processor 21 or other components.

The driver controller 29 can take the raw image data generated by the processor 21 either directly from the processor 21 or from the frame buffer 28 and can re-format the raw image data appropriately for high speed transmission to the array driver 22. In some implementations, the driver controller 29 can re-format the raw image data into a data flow having a raster-like format, such that it has a time order suitable for scanning across the display array 30. Then the driver controller 29 sends the formatted information to the array driver 22. Although a driver controller 29 is often associated with the system processor 21 as a stand-alone Integrated Circuit (IC), such controllers may be implemented in many ways. For example, controllers may be embedded in the processor 21 as hardware, embedded in the processor 21 as software, or fully integrated in hardware with the array driver 22.

The array driver 22 can receive the formatted information from the driver controller 29 and can re-format the video data into a parallel set of waveforms that are applied many times per second to the hundreds, and sometimes thousands (or more), of leads coming from the display's x-y matrix of display elements. In some implementations, the array driver 22 and the display array 30 are a part of a display module. In some implementations, the driver controller 29, the array driver 22, and the display array 30 are a part of the display module.

In some implementations, the driver controller 29, the array driver 22, and the display array 30 are appropriate for any of the types of displays described herein. For example, the driver controller 29 can be a conventional display controller or a bi-stable display controller (such as a mechanical light modulator display element controller). Additionally, the array driver 22 can be a conventional driver or a bi-stable display driver (such as a mechanical light modulator display element controller). Moreover, the display array 30 can be a conventional display array or a bi-stable display array (such as a display including an array of mechanical light modulator display elements). In some implementations, the driver controller 29 can be integrated with the array driver 22. Such an implementation can be useful in highly integrated systems, for example, mobile phones, portable-electronic devices, watches or small-area displays.

In some implementations, the input device 48 can be configured to allow, for example, a user to control the operation of the display device 40. The input device 48 can include a keypad, such as a QWERTY keyboard or a telephone keypad, a button, a switch, a rocker, a touch-sensitive screen, a touch-sensitive screen integrated with the display array 30, or a pressure- or heat-sensitive membrane. The microphone 46 can be configured as an input device for the display device 40. In some implementations, voice commands through the microphone 46 can be used for controlling operations of the display device 40. Additionally, in some implementations, voice commands can be used for controlling display parameters and settings.

The power supply 50 can include a variety of energy storage devices. For example, the power supply 50 can be a rechargeable battery, such as a nickel-cadmium battery or a lithium-ion battery. In implementations using a rechargeable battery, the rechargeable battery may be chargeable using power coming from, for example, a wall socket or a photovoltaic device or array. Alternatively, the rechargeable battery can be wirelessly chargeable. The power supply 50 also can be a renewable energy source, a capacitor, or a solar cell, including a plastic solar cell or solar-cell paint. The power supply 50 also can be configured to receive power from a wall outlet.

In some implementations, control programmability resides in the driver controller 29 which can be located in several places in the electronic display system. In some other implementations, control programmability resides in the array driver 22. The above-described optimization may be implemented in any number of hardware and software components and in various configurations.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, i.e., one or more modules of computer program instructions, encoded on a computer storage media for execution by, or to control the operation of, data processing apparatus.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein.

Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of any device as implemented.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, other implementations are within the scope of the following claims. In some cases, the actions recited in the claims can be performed in a different order and still achieve desirable results.

What is claimed is:

1. A display device comprising:
a substrate;
a first light modulator; and
a first electrostatic actuator configured to induce rotational movement of the first light modulator in a plane substantially parallel to the substrate, the first electrostatic actuator including:
a first anchor coupled to the substrate and positioned adjacent to a proximal end of the first light modulator;
a first drive beam electrode coupled to a second anchor; and
a first load beam electrode coupled at a first end to the first anchor, and coupled at a second end to a first edge of the first light modulator at a point closer to a distal end of the first light modulator than to the proximal end of the first light modulator,
wherein the first load beam electrode is configured to move towards the first drive beam electrode in response to the application of a voltage across the first load beam electrode and the first drive beam electrode.

2. The display device of claim 1, further comprising a second electrostatic actuator including:
a second drive beam electrode coupled to a second anchor; and
a second load beam electrode opposed to the second drive beam electrode, coupled at a first end to the first anchor, and coupled at a second end to a second edge of the first light modulator, substantially opposite the first edge, at a point closer to the distal end of the first light modulator than to the proximal end of the first light modulator, wherein the second load beam electrode is configured to move towards the second drive beam electrode in response to the application of a voltage across the second load beam electrode and the second drive beam electrode.

3. The display device of claim 1, wherein a length of the first light modulator from a center of the proximal end to a center of the distal end is greater than a length of the first edge.

4. The display device of claim 1, further comprising an elevated aperture layer (EAL) positioned on a side of the first light modulator opposite the substrate, wherein:
the EAL is positioned within a plane substantially parallel to the substrate;
the first light modulator further comprises at least one light modulator aperture; and
the EAL includes at least one aperture aligned with the at least one light modulator aperture when the first light modulator is in an open state.

5. The display device of claim 1, wherein the first load beam has a length of less than about 100 microns.

6. The display device of claim 1, further comprising:
a second light modulator adjacent to the first light modulator, the display device further comprising a second electrostatic actuator configured to induce rotational movement of the second light modulator in a plane substantially parallel to the substrate, wherein a centerline of the second light modulator is oriented at an angle with respect to a centerline of the first light modulator when the first light modulator and the second light modulator are in an unactuated state.

7. The display device of claim 6, wherein the angle formed by the centerline of the first light modulator and the centerline of the second light modulator when the first light modulator and the second light modulator are in an unactuated state is about 90 degrees.

8. The display device of claim 6, further comprising a second load beam electrode coupled at a first end to a second anchor, and coupled at a second end to a first edge of the second light modulator at a point closer to a distal end of the second light modulator than to the proximal end of the second light modulator, wherein:
a distance between the proximal end of the first light modulator and the proximal end of the second light modulator is shorter than a distance between the distal end of the first light modulator and the distal end of the second light modulator.

9. The display device of claim 6, further comprising a second load beam electrode coupled at a first end to a second anchor, and coupled at a second end to a first edge of the second light modulator at a point closer to a distal end of the second light modulator than to the proximal end of the second light modulator, wherein:
a distance between the distal end of the first light modulator and the distal end of the second light modulator is shorter than a distance between the proximal end of the first light modulator and the proximal end of the second light modulator.

10. The display device of claim 6, wherein the first electrostatic actuator of the first light modulator and the second electrostatic actuator of the second light modulator share a common actuation voltage connection.

11. The display device of claim 1, further comprising:
a processor capable of communicating with the display device, the processor being capable of processing image data; and
a memory device capable of communicating with the processor.

12. The apparatus of claim 11, further comprising:
a driver circuit capable of sending at least one signal to the display device; and
a controller capable of sending at least a portion of the image data to the driver circuit.

13. The apparatus of claim 11, further comprising:
an image source module capable of sending the image data to the processor, wherein the image source module includes at least one of a receiver, transceiver, and transmitter.

14. The apparatus of claim 11, further comprising:
an input device capable of receiving input data and to communicate the input data to the processor.

15. A display device comprising:
a substrate;
a first light modulator; and
a first electrostatic actuator configured to induce rotational movement of the first light modulator in a plane substantially parallel to the substrate, the first electrostatic actuator including:
a first anchor coupled to the substrate and positioned adjacent to a proximal end of the first light modulator;
a first drive beam electrode coupled to a second anchor; and
a first load beam electrode coupled at a first end to the first anchor, and coupled at a second end to a first distal edge of the first light modulator away from the proximal end, wherein the first load beam electrode is configured to move towards the first drive beam electrode in response to the application of a voltage across the first load beam electrode and the first drive beam electrode.

16. The display device of claim 15, further comprising a second electrostatic actuator including:
a second drive beam electrode coupled to a second anchor; and
a second load beam electrode opposed to the second drive beam electrode, coupled at a first end to the first anchor, and coupled at a second end to a second distal edge of the first light modulator, substantially opposite the first distal edge and away from the proximal end, wherein the second load beam electrode is configured to move towards the second drive beam electrode in response to the application of a voltage across the second load beam electrode and the second drive beam electrode.

17. The display device of claim 15, wherein a length of the first light modulator from a center of the proximal end to a center of the distal end is greater than a length of an edge of the first light modulator connecting the proximal end and the distal end.

18. The display device of claim 15, further comprising an elevated aperture layer (EAL) positioned on a side of the first light modulator opposite the substrate, wherein:
the EAL is positioned within a plane substantially parallel to the substrate;
the first light modulator further comprises at least one light modulator aperture; and
the EAL includes at least one aperture aligned with the at least one light modulator aperture when the first light modulator is in an open state.

19. The display device of claim 15, wherein the first load beam has a length of less than about 100 microns.

20. The display device of claim 15, further comprising:
a second light modulator adjacent to the first light modulator, the display device further comprising a second electrostatic actuator configured to induce rotational movement of the second light modulator in a plane substantially parallel to the substrate, wherein a centerline of the second light modulator is oriented at an angle with respect to a centerline of the first light modulator when the first light modulator and the second light modulator are in an unactuated state.

21. The display device of claim 20, wherein the angle formed by the centerline of the first light modulator and the centerline of the second light modulator when the first light modulator and the second light modulator are in an unactuated state is about 90 degrees.

22. The display device of claim 20, further comprising a second load beam electrode coupled at a first end to a second anchor, and coupled at a second end to a first edge of the second light modulator at a point closer to a distal end of the second light modulator than to the proximal end of the second light modulator, wherein:
a distance between the proximal end of the first light modulator and the proximal end of the second light modulator is shorter than a distance between the distal end of the first light modulator and the distal end of the second light modulator.

23. The display device of claim 20, further comprising a second load beam electrode coupled at a first end to a second anchor, and coupled at a second end to a first edge of the second light modulator at a point closer to a distal end of the second light modulator than to the proximal end of the second light modulator, wherein:
a distance between the distal end of the first light modulator and the distal end of the second light modulator is shorter than a distance between the proximal end of the first light modulator and the proximal end of the second light modulator.

24. The display device of claim 20, wherein the first electrostatic actuator of the first light modulator and the second electrostatic actuator of the second light modulator share a common actuation voltage connection.

25. A display device comprising:
a substrate;
a first light modulator;
a first anchor coupled to the substrate and positioned adjacent to a proximal end of the first light modulator;
a first electrostatic actuator configured to induce rotational movement of the first light modulator in a plane substantially parallel to the substrate, the first electrostatic actuator including:
a first drive beam electrode coupled to a second anchor;
a first load beam electrode coupled at a first end to the first anchor, and coupled at a second end to a first edge of the first light modulator; and
a second load beam electrode coupled at a first end to the first anchor, and coupled at a second end to a second edge of the first light modulator, and wherein the first light modulator is positioned between the first load beam electrode and the second load beam electrode.

26. The display device of claim 25, further comprising:
a second electrostatic actuator configured to induce rotational movement of the first light modulator in the plane substantially parallel to the substrate, the second electrostatic actuator including:
the second load beam electrode; and
a second drive beam electrode opposed to the second load beam electrode and coupled to a third anchor.

27. The display device of claim 25, wherein the first light modulator further comprises at least a first light modulator aperture and a second light modulator aperture, wherein an area of the first light modulator aperture is larger than an area of the second light modulator aperture.

28. The display device of claim 27, further comprising an elevated aperture layer (EAL) positioned on a side of the first light modulator opposite the substrate, wherein:
the EAL is positioned within a plane substantially parallel to the substrate; and
the EAL includes at least two apertures each aligned with a respective one of the first light modulator aperture and the second light modulator aperture when the first light modulator is in an open state.

29. The display device of claim 25, wherein the first load beam has a length of less than about 100 microns.

30. The display device of claim 25, further comprising:
a second light modulator adjacent to the light modulator; and
a second electrostatic actuator configured to induce rotational movement of the second light modulator in a plane substantially parallel to the substrate, wherein a centerline of the second light modulator is oriented at an angle with respect to a centerline of the first light modulator when the first light modulator and the second light modulator are in an unactuated state.
